(19) United States
(12) Patent Application Publication
(10) Pub. No.: US 2002/0019802 A1
(43) Pub. Date: Feb. 14, 2002

(54) System and methods for aggregation and liquidation of curtailment energy resources

(76) Inventors: Ross Malme, Atlanta, GA (US); Peter C. Scarpelli, Chicago, IL (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/954,852

(22) Filed: Sep. 18, 2001

Related U.S. Application Data
(60) Provisional application No. 60/223,419, filed on Aug. 7, 2000.

(51) Int. Cl. G06F 17/60

(52) U.S. Cl. 705/37

(57) ABSTRACT

The virtual utility manager (“VUM”) is a focal point for the aggregation and liquidation of curtailment energy assets. The VUM receives curtailment energy commitments from energy consumers or load-supplying entities (LSEs) who have executed load curtailment contracts with energy consumers. These load-supplying entities as well as energy consumers desire the ability to market their curtailment assets. The VUM can aggregate the commitments and provide the aggregate energy commitments to energy market participants. The VUM also monitors curtailment performance and provide this monitoring information to the involved participants.

### CROSS REFERENCE TO RELATED APPLICATIONS

The following U. S. Patent Application claims priority under 35 U.S.C. §119 to United States Provisional Application number 60/223,419 filed on Sep. 18, 2000.

### TECHNICAL FIELD

The invention relates generally to the field of network-based services and, more particularly, to a virtual utility system and method that aggregates and markets curtailment energy resources.

### BACKGROUND OF THE INVENTION

The energy crisis in California during the winter of 2001 re-sparked the nation's interest in energy availability. Rolling blackouts dimmed sizable portions of Northern and Central California during the coldest part of a January Arctic blast. The energy shortage was exacerbated by the inability of Southern California to transmit excess energy through a bottleneck in the transmission lines through the Central Valley. The capacity of these transmission lines limits the amount of energy that can be delivered from the lower part of the state to the upper regions. As thousands went without power, the debate about California's implementation of energy deregulation heated up. As energy prices soared, California's legislated mandate, which capped the price that energy consumers could be charged, resulted in the State's two largest utilities facing potential bankruptcy.

The United States is currently in a process of deregulating the providers of energy. In a deregulated environment, energy consumers are able to buy energy from multiple energy providers. In this deregulated environment, energy prices will vary depending on demand. During peak, demand periods, such as cold winters and hot summers, the price for energy can sky rocket. During these peak demand periods, the amount of commercial energy reserves diminishes and energy prices correspondingly rise. As the available commercial energy reserves dwindle to near zero, prices can escalate to record highs.

The United States alone has about 750,000 megawatts of maximum demand. These However, during peak demand, the United States is between 5% to 10% short on capacity. Therefore, an energy market exists for 40,000 to 80,000 megawatts of new energy supplies. This energy can be made available from the building of new power plants or from more efficient usage of current energy supplies.

Many energy-consuming facilities have onsite generation capabilities that typically do not provide energy except in the rare event where the facility loses offsite power. Each one of these generators do not provide a monumental amount of energy, yet in the aggregate can provide a significant amount of energy. This untapped energy source can provide relief in times of commercial energy shortages. Additionally, as energy prices escalate consumers tend to reduce their energy consumption. However, many energy consumers may have fixed price contracts that insulate the consumer from most of the effects of a varying market. These consumers have little incentive to radically reduce their energy consumption. Yet, with the proper incentive, nearly every energy consumer has the capability of significantly curtailing their energy consumption. If multiple energy consumers could be provided with an adequate incentive to reduce their consumption, a significant amount of energy would be available for other consumers.

The Federal Energy Regulatory Commission (FERC) is dividing the country in reliability zones or retail transmission organizations (RTOs). An RTO will have the authority to coordinate transmission with their reliability zone. FERC has mandated that each RTO have in place a mechanism to provide energy demand feedback. Thus, a mechanism to reduce energy demand during demand shortages has been mandated by the government. Even modest demand reductions can have a significant effect on the price of energy during peak periods.

If this curtailment energy could be brought to the energy markets, the summation of the energy resource could supply a region with critical energy reserves at the time the energy is most needed. A system for load management dispatch that provides for the economic dispatch of distributed generation and load reduction assets has already been implemented by Retx.com, Inc. and described in patent application Ser. No. 09/795,371. patent application Ser. No. 09/795,371 is incorporated by reference in its entirety. However, what is needed is the ability to aggregate available curtailment energy and liquidate the resultant energy.

A system is needed that not only can bring the curtailment energy reserves to the wholesale markets, but the system will need to be able to aggregate the reserves into quantities attractive to most of the wholesale market participants. Market wholesale purchasers may desire certain curtailment categorizes, such as clean energy from load shedding, in specific regions in sizable quantities. The system will need to be able to aggregate and provide the available curtailment reserves from desired categories. The system will also need to monitor the performance of the curtailment activities and supply this information to the market participants.

In effect, the aggregation of the energy curtailments could act as virtual utility supplying the region with vital energy supply during peak demand periods. Clearly, the system will not produce energy in the conventional sense, but will supply energy reserves during energy price spikes.

If energy consumers can be transformed into potential energy sellers, a significant amount of untapped energy resources can be made available during peak demand periods when the energy is needed the most. The net effect would lower peak energy prices, which would be enjoyed by all energy consumers. The energy could be available in the regions where the demand is the highest reducing the problem of transmission bottlenecks. Additionally, fewer power plants would need to be built to provide reserves in those limited instances of energy shortages. The total amount of energy that can be provided by aggregating all onsite generation capacity and load curtailment is phenomenal. A virtual utility is needed that can aggregate energy curtailment and provide a mechanism to liquidate the energy curtailment to the benefit of all market participants.

### SUMMARY OF THE INVENTION

The present invention meets the needs described above in a virtual utility manager. The virtual utility manager (“VUM”) is a focal point for the aggregation and liquidation of curtailment energy assets. The VUM receives curtailment energy commitments from energy consumers or load-supplying entities (LSEs) who have executed load curtailment contracts with energy consumers. These load-supplying entities as well as energy consumers desire the ability to market their curtailment assets. The VUM can aggregate the commitments and provide the aggregate energy commitments to energy market participants.

Trading desks of energy companies can optimize their energy portfolios by purchasing call options on aggregate energy curtailments. Energy companies have contracts to supply energy to their energy-consuming clients. In times of peak demand, it may be cheaper to pay for curtailment energy reserves than to buy energy on the energy markets.

Entities responsible for grid management are also interested in purchasing the rights to curtailment energy reserves. These entities are mandated to maintain the reliability of the energy grid in the geographic region under their control. They can utilize curtailment energy assets as energy reserves in place of commercial power generating plants in times of peak demand. Peak demand times are when additional power reserves are needed. The ability to call upon these reserves decreases the need to build additional power plants.

The VUM can aggregate the curtailment commitments such that the commitments are readily marketable. Most wholesale energy participants will desire to have more than minimal amounts of curtailment energy available upon request. In addition, some purchasers may desire only curtailment reserves in a certain geographic region. Mandatory curtailment may be sought rather than voluntary curtailment options. The VUM can group voluntary curtailments by their associated energy-clearing price. The VUM can also aggregate the curtailment assets by availability such as the time of day or day of week or whether the reserve energy is from load shedding or onsite generation. Additionally, the VUM can aggregate curtailment energy assets by whether the asset is environmentally friendly. During ozone non-attainment days, energy obtained from diesel generators may not be desirable while energy availability from load shedding, onsite battery group, or onsite gas turbine may be highly desirable. Additional categories may include the notification lead time required, the ramp time to effect the curtailment, and other categories that may be desired by energy purchasers. The VUM can aggregate the curtailment asset by desired categories.

The VUM offers aggregate curtailment assets to wholesale energy purchasers. The energy purchasers than can request performance of the curtailment and the VUM can automatically make the required notifications. In addition, the VUM can monitor the curtailment performance, calculate the remuneration for the performance, and provide settlement activities. In sum, the VUM can provide meter to control room service for curtailment events.

Generally described, the invention is a system and method for energy load curtailment. The VUM receives curtailment energy commitment from load-supplying entities or directly from energy consumers. The curtailment energy commitment data is generally received via real time online communications via a communication network such as the Internet.

The curtailment energy commitment is aggregated to provide energy reserves that will be attractive to wholesale energy purchasers. The curtailment commitments are aggregated to achieve quantities or reserves desired. The VUM then provides the aggregated curtailment commitments to energy market purchasers.

The VUM aggregates and markets curtailment assets. The rights and obligations of the parties involved are generally defined by contracts. The VUM can receive and store contract information. From this contract information, the VUM can determine the remuneration for the parties involved in a curtailment event. In the event that a curtailment contract does not exist, the VUM can provide standardized contracts and execute the contracts electronically.

The VUM can perform optimization calculation. Valuation calculations based upon estimated future demand can be performed based upon the weather, expected demand, power generation availability, and similar functions.

Upon receiving a curtailment request from a purchaser of curtailment energy reserves, the VUM can automatically perform dispatch notification of the selected participants of the curtailment event. Installed meters enable the VUM can monitor the curtailment performance. The performance data can be provided to all of the participants of the curtailment event. Consequently, the VUM can provide meter to control room service.

### BRIEF DESCRIPTION OF THE DRAWINGS

FIG. 1 is a functional block diagram illustrating a virtual utility system.

FIG. 2 is a functional block diagram illustrating virtual utility dispatch system.

FIG. 3 is a functional block diagram illustrating a VUM hardware architecture.

FIG. 4 is a functional block diagram illustrating a VUM software architecture.

FIG. 5 is a functional block diagram illustrating a data file structure for information stored in association with the VUM database.

FIG. 6 is a functional block diagram illustrating basic message formats for communications.

FIG. 7 is a logic flow diagram illustrating a virtual utility manager main process routine.

FIG. 8 is a logic flow diagram illustrating an aggregate curtailment routine.

FIG. 9 is a logic flow diagram illustrating a curtailment information receipt routine.

FIG. 10 is a logic flow diagram illustrating a contract execution routine.

FIG. 11 is a logic flow diagram illustrating a curtailment aggregate routine.

FIG. 12 is a logic flow diagram illustrating an aggregate optimization routine.

FIG. 13 is a logic flow diagram illustrating an aggregate liquidation routine.

FIG. 14 is a logic flow diagram illustrating a load dispatch routine.

FIG. 15 is a logic flow diagram illustrating a dispatch routine.

FIG. 16 is a logic flow diagram illustrating a curtailment monitor routine.

FIG. 17 is a screen shot illustrating a dashboard summary page.

FIG. 18 is a screen shot illustrating a notification manger mandatory curtailment page.

FIG. 19 is a screen shot illustrating a notification manger voluntary curtailment page.

FIG. 20 is a screen shot illustrating a notification manager restoration page.

### DETAILED DESCRIPTION OF THE EMBODIMENTS

The described embodiment discloses a system that aggregates and liquidates curtailment energy resources. The virtual utility manager creates a market opportunity for trading exchanges, Independent System Operators (ISOs), Load supply Entities (LSEs), the energy consumers, and other market participants. The system also provides an ISO or other entity charged overseeing energy supply with an additional tool to manage the supply in order to meet demand. Although the described embodiment refers to a system in an electrical energy context, those skilled in art can readily appreciate that the system is equally advantageous with other energy commodities including natural gas.

The virtual utility manager receives capacity and energy from customers who are willing to curtail energy usage when market prices are high. Independent System Operators can utilize contracted curtailment energy as energy reserves for grid management in the region of their control. Trading desks may desire to enhance their positions by utilizing curtailment energy. However, it does not own any generating resources. The virtual utility manager provides the energy to the wholesale energy markets, thus, functions as a generation clearinghouse. Nevertheless, the potential to provide energy in times of high demand and limited supply closely replicates the abilities of a conventional utility.

If the market price exceeds the consumer's load shedding cost or self-generating cost, it can be more economically advantageous for the energy consumer to reduce its usage by deploying its load management strategy than to take power from the grid. The energy consumer can reduce its load demand and be in a position to sell the resultant energy to an energy market. In the aggregate, these reductions can become significant. The system creates a marketplace that can aggregate load curtailments and provide the resultant aggregate energy to the whole markets.

As a result, the system allows market participants to react to, and profit from, fluctuations in hourly market prices. The system is a dynamic process that delivers the energy market to the energy consumer. The energy consumer can directly profit from changes in market. The system provides energy consumers with the ability to directly participate in the energy market as a seller rather than merely as a buyer.

The virtual utility manager heeds the call from government, consumer advocates, and environmental groups to utilize conservation to help resolve the current power supply crisis. Accordingly, wide spread usage of the system can yield significant societal benefits in tapping previously unavailable energy assets.

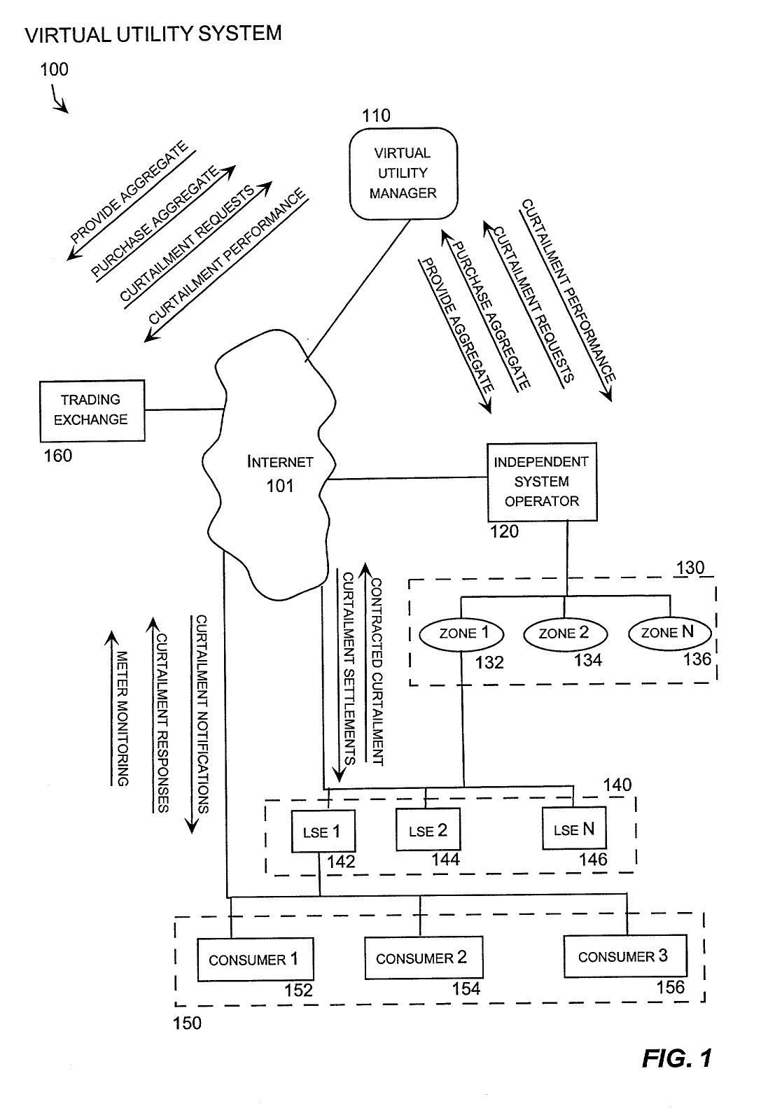

Turning to the figures, in which like numerals indicate like elements throughout the several figures, FIG. 1 illustrates a virtual utility system 100 constructed in accordance with an embodiment of the present invention. The system 100 is connected for computer communications via a known global computer network commonly known as the Internet 101. It is known in the art to send packets of information via the Internet. One common protocol for the transfer of data via the Internet 101 is the Transfer Control Protocol/Internet Protocol (TCP/IP).

The disclosed virtual utility system 100 provides a system for aggregating and marketing curtailment energy resources. An energy consumer 150 can manage its energy costs by reducing consumption or utilizing its energy reserves during times of peak energy demand. Considerable monetary savings can be achieved by the deployment of energy curtailment resources during periods of spiked energy prices. In addition, the resultant energy available from the energy curtailment has significant monetary value, if marketed.

Energy consumers 150 typically contract with a load-supplying entity 140 to provide the consumer 150 with their energy needs. As illustrated, consumers 152, 154, 156 have a contract relationship with load supply entity (LSE) 142. Contract terms can include mandatory curtailment requirements in exchange for cheaper rates. Additionally, the contract terms can include voluntary curtailment when energy prices are extremely high. In exchange for reduction of demand, the energy consumer 150 receives compensation from the sale of the resultant energy available from the curtailment. The revenue sharing can be a fixed price per megawatt, a percent of the sales price over the operating expense of the curtailment, or any other revenue sharing model. The LSE 140 electronically provides the load management contract terms to the VUM 110. The described embodiment contemplates that that electronic data will be transmitted in a known manner via the Internet 101.

Load-supplying entities 142, 144, 146 are entities that have title to electrical power and energy. These load-supplying entities 140 include local distribution companies and utility distribution companies. These LSEs provide the virtual utility manager 110 with the curtailment terms contracted with their customers, the energy consumers 150. In addition, the LSEs 140 upload a load forecast based upon its energy consumers' predicted demand to the independent system operator (ISO) 120. The ISO 120 has the responsibility of grid management.

The Virtual Utility Manager (VUM) 110 can process the provided contract terms and provide the curtailment information to the ISO 120. ISOs are willing to buy curtailment energy to assist in management of the electrical grid under their supervision.

The curtailment information can be presented to the ISO 120 in various forms to facilitate the grid management. The aggregate energy curtailment information can be provided for each zone 130. For example, if a certain area in the ISO regional coverage is need of energy, the VUM 110 can provide information specifying the amount of curtailment available in that zone 130. As illustrated, if the ISO 110 was interested in the curtailment energy available in zone 1 142, the VUM 110 would provide information from LSE 1 142, LSE 2 144 and LSE N 146. The curtailment information is categorized by whether the curtailment is mandatory or voluntary. In addition, the ramp up time, the advance notification time required, the availability by day of week or time of day, the type of curtailment, and similar information is provided. Furthermore, the consumer historical response to voluntary curtailment requests is available. This information can greatly aid in the ISO's management of the grid and resources. For example, during an ozone non-attainment day, the ISO would not want to request curtailment reserves created by running a diesel generator. The curtailment information in the described embodiment is contemplated being electronically transferred via the Internet utilizing known client-server web browser technology.

Alternatively, energy consumers 150 or LSEs 140 may desire to sell their curtailment reserves to energy markets. If the available curtailment energy is sufficiently large, typically at least 100 kilowatts, the VUM will provide the curtailment to various trading exchanges 160. These exchanges 160 include actual energy exchanges or the trading desks of energy market providers. For small curtailment quantities, the VUM 110 can aggregate and then liquidate these assets. The VUM 110 will provide on-line form contracts to effectuate the curtailment.

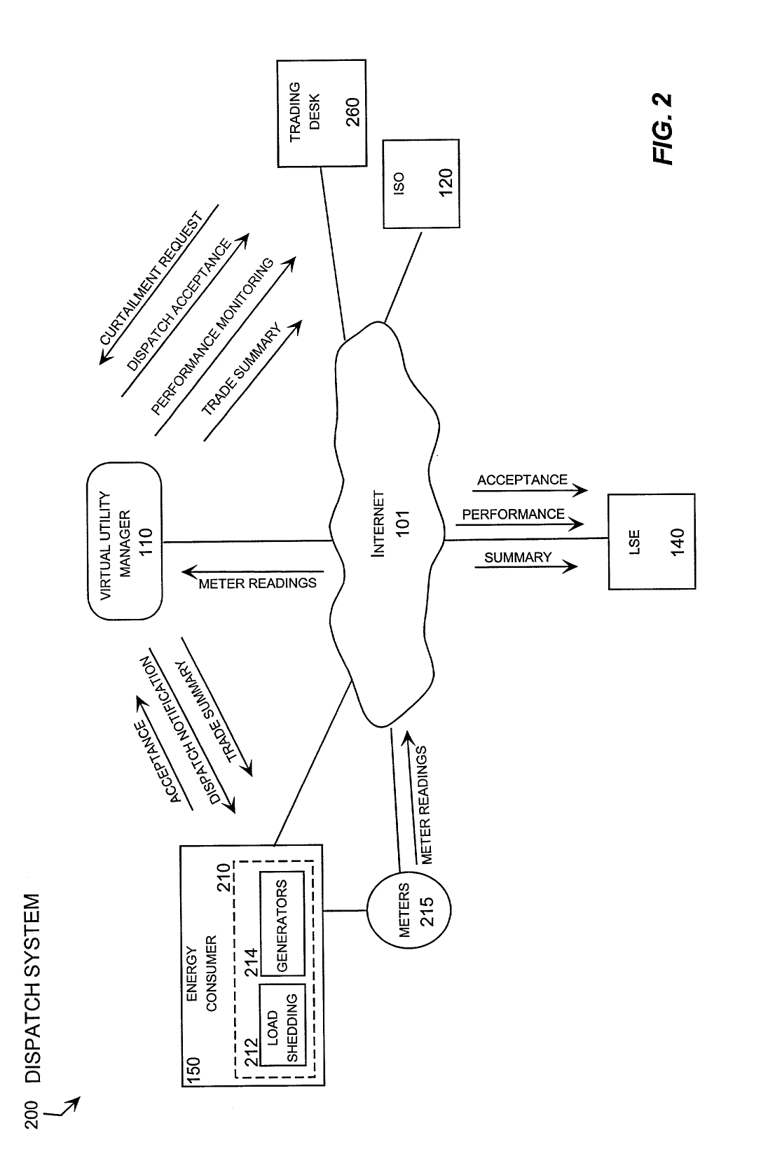

In addition, the VUM 110 also provides the infrastructure to effectuate the curtailment requests. If market conditions exists such that either by the trading exchanges 160 or the ISOs 120 desire to request energy consumers to perform contracted energy curtailment, the VUM electronically receives the requests and automatically notifies the energy consumers 154. In addition, the VUM 110 is responsive to the energy consumers responses, monitors the performance, and provides settlement information to the parties involved. The dispatch system is described in greater detail in reference to FIG. 2.

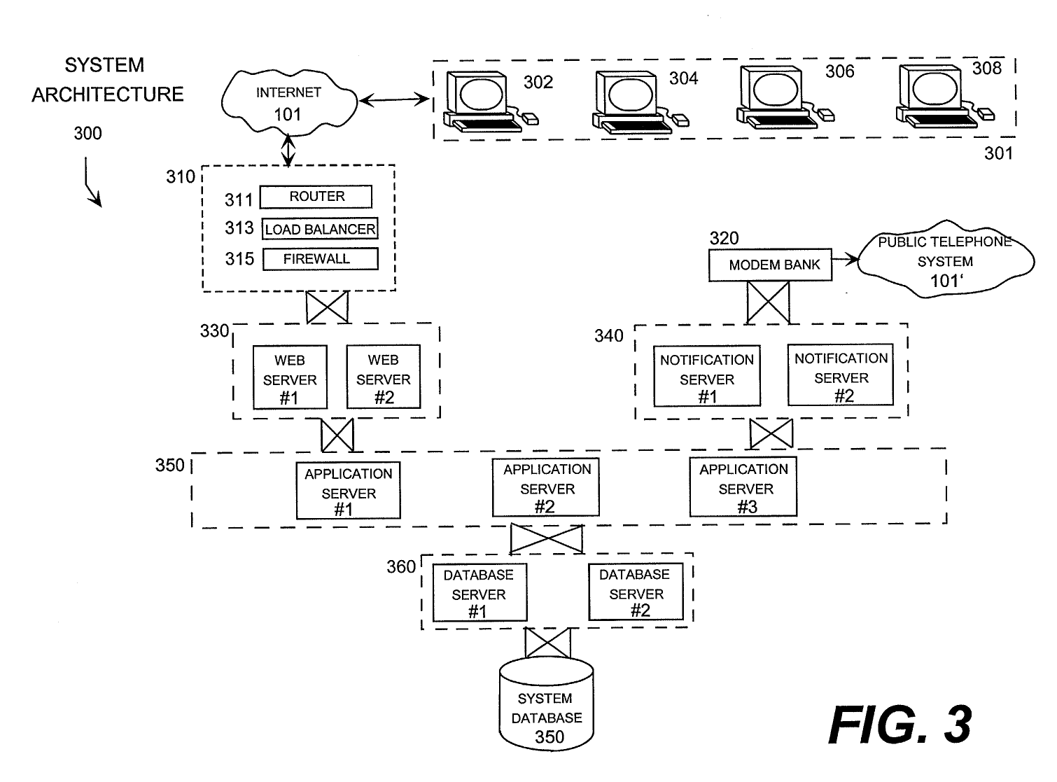

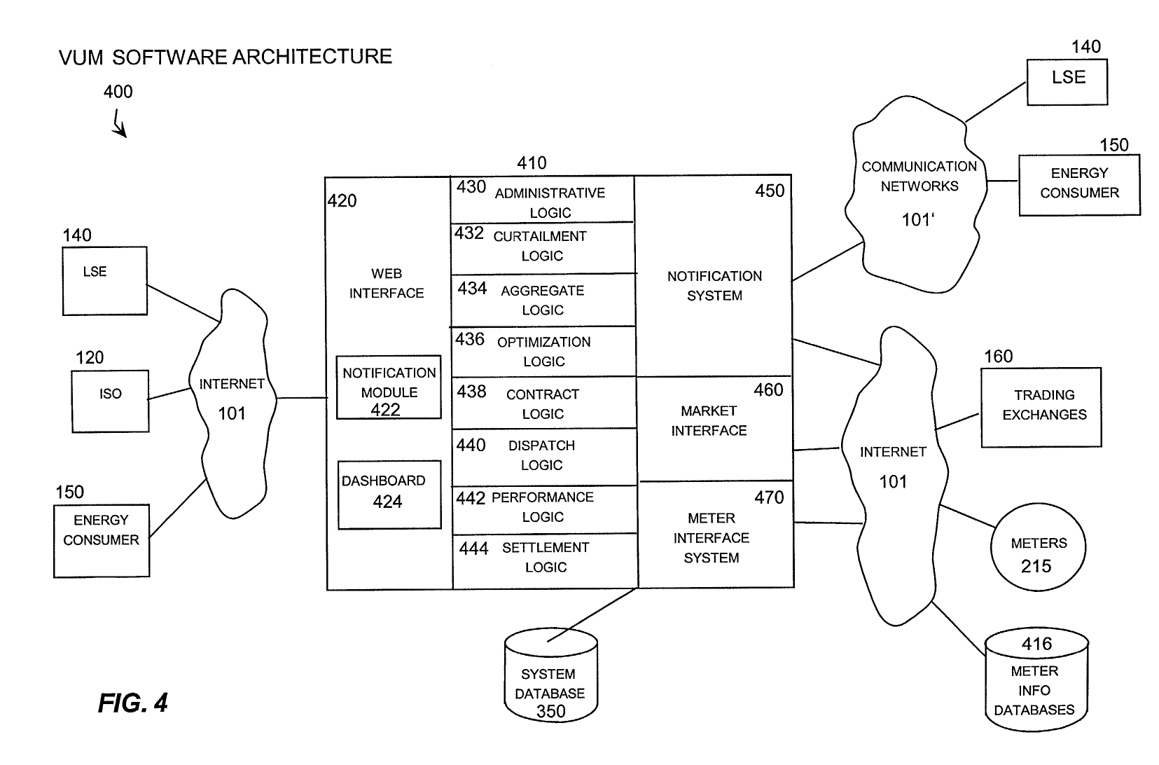

FIG. 2 illustrates an embodiment of a virtual utility manager dispatch system. The hardware architecture of the virtual utility manger is described in greater detail in reference to FIG. 3, and the software architecture is described in greater detail in reference to FIG. 4.

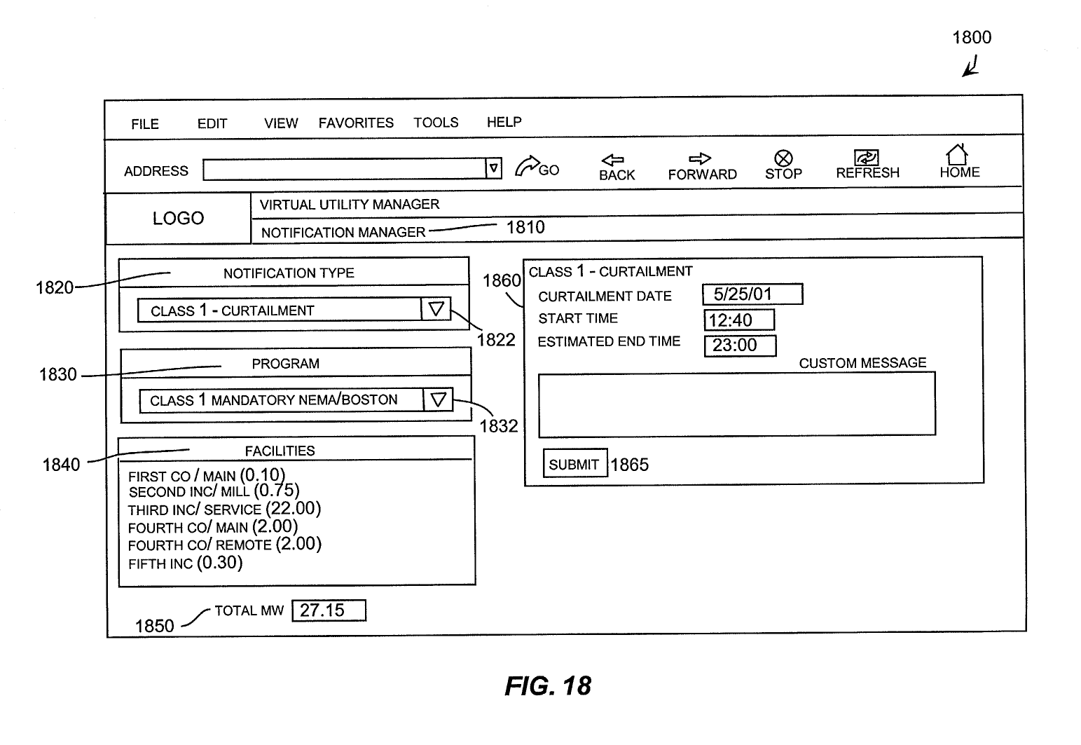

When demand approaches the available supply, prices for energy dramatically escalates. During such energy spikes, an ISO 120 or a trading desk 260 may decide to implement their executed curtailment contracts. The notification requests are initiated by interfacing with the notification module at the VUM 110. The client systems at a trading desk 260 or an ISO 120 interface with the VUM 110 by running browsing applications that retrieve the system's web pages. FIGS. 18-20 illustrate embodiments of screen shots generated by the notification module.

The notification module provides the necessary curtailment information to select the desired energy consumer for load management dispatch performance. Information provided includes whether the curtailment is mandatory or voluntary, the energy-clearing price, the resultant area, the available facilities, and the available megawatts available from the curtailment. The trading desk 260 or the ISO 120 via interaction with a browser application submits the curtailment notification request.

The VUM 110 automatically notifies the LSE 140 that has contracted for curtailment options with energy consumers or the energy consumer 150 directly if the consumer has directly liquidated its guaranteed energy supply. The notification can be accomplished by an e-mail delivered by the Internet 101. Other contemplated notification means include an automatically generated telephone call, a facsimile, a wireless communication delivered via a wireless transmitter to a pager, mobile phone, or other wireless device, a wireless message delivery by wireless application protocol (WAP) to a hand held computing device, or other suitable methods for delivering the message.

If the curtailment is voluntary, a decision is made whether to accept the curtailment request. This decision is typically communicated by a browser application interacting with the notification module. The acceptance or rejection of voluntary curtailment is automatically posted on the notification module. However, some contracts may include terms that may not allow the energy consumer 150 to decline the curtailment notification. The VUM 110 identifies the total amount of load that should be reduced.

If the LSE 140 decides to act upon the notification, the LSE 140 informs the VUM 110 of which customer groups to notify of the curtailment opportunity. The LSE 140 can inform the VUM 110 of the consumer groups to notify by electronically transmitting a file in a known manner via the Internet. Alternatively, the system contemplates that the LSE 140 can access, by known operation of a web browser, a notification module at the web site operated by the VUM 110. The notification module can automatically contact the energy consumer 150.

The energy curtailment performance is monitored by the VUM 110. A consumer's load management performance can be measured by the difference of the consumer's projected load minus their actual load during an event or by a measurement of the actual self-generated output. Meters 215 can monitor the energy provided by onsite generators 214 or the reduction of energy supplied to a facility due to employing load-shedding assets 212. Preferably, the energy consumer 150 has installed meters 115 that can provide real time usage data directly to the VUM 110 over the Internet 101. However, meters 115 can also be read periodically with the data transmitted after the termination of a curtailment event. In any event, meters 115 track the energy consumers curtailment performance, and the curtailment data is obtained by the VUM 110. The results of the performance monitoring is provided on a dashboard accessible via the Internet by a browser application.

In certain instances, the VUM can generate and transmit a signal that will automatically effectuate the load curtailment. This signal can start an on-site generator 214 or shed energy-consuming assets 214. An automated reduction will be most desirable in unmanned or remote facilities.

After the curtailment event is completed, the VUM 110 automatically generates a performance summary. The VUM 110 has previously stored contract information. Based upon the performance and contract terms, the VUM can calculate the financial compensation for entities that participated in the curtailment. This information is accessible on the dashboard and is electronically provided for remittance by the curtailment requesting entity.

FIG. 3 and the subsequent figures provide illustrations for a discussion of a series of message formats, data structure diagrams, hardware and software architectures, process diagrams in the form of flow charts, and user interface screen shots that illustrate an exemplary embodiment of a system and corresponding methods for the disclosed virtual utility system 100.

FIG. 3 discloses a logical hardware architecture of the virtual utility manager 110 constructed in accordance with an embodiment of the present invention. As will be understood in the art, the system is constructed utilizing Internet-enabled computer systems with computer programs designed to carry out the functions described herein. The computer programs are executed on computer systems constructed as described in reference to FIG. 3. Although the disclosed embodiments are generally described in reference to Internet-accessible computers including the virtual utility system 100, those skilled in the art will recognize that the present invention can be implemented in conjunction with other program modules for other types of computers.

The disclosed embodiment of the present invention is implemented in a distributed computing environment such as the Internet. In a distributed computer environment, program modules may be physically located in different local and remote memory storage devices. Execution of the program modules may occur locally in a stand-alone manner or remotely in a client/server manner. By way of illustration and not limitation, distributed computing environments include local area networks (LAN) of an office, enterprise-wide area networks (WAN), and the global Internet (wired or wireless connections). Accordingly, it will be understood that the terms computer, operating system, and application program include all types of computers and the program modules designed to be implemented by the computers.

The discussion of methods that follows, especially in the flow charts, is represented largely in terms of processes and symbolic representations of operations by conventional computer components, including a central processing unit (CPU), memory storage devices for the CPU, connected display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network.

The processes and operations performed by the computer include the manipulation of signals by a CPU, or remote server such as an Internet web site, and the maintenance of these signals within data structures reside in one or more of the local or remote memory storage devices. Such data structures impose a physical organization upon the collection of data stored within a memory storage device and represent specific electrical, optical, or magnetic elements. These symbolic representations are the means used by those skilled in the art of computer programming and computer construction to effectively convey teachings and discoveries to others skilled in the art.

For the purposes of this discussion, a process is understood to include a sequence of computer-executed steps leading to a concrete, useful, and tangible result, namely, the aggregation and liquidation of energy curtailment assets.

These steps generally require manipulations of quantities such as available curtailment energy, meter data, dispatch notifications, acceptance information, megawatts traded, associated dollar values, identifiers of clients, consumers and premises, and other related transactional information. Usually, though not necessarily, these quantities take the form of electrical, magnetic, or optical signals capable of being stored, transferred, combined, compared, or otherwise manipulated. It is conventional for those skilled in the art to refer to these signals as bits, bytes, words, values, elements, symbols, characters, terms, numbers, points, records, objects, images, files or the like. It should be kept in mind, however, that these and similar terms should be associated with appropriate quantities for computer operations, and that these terms are merely conventional labels applied to quantities that exist within and during operation of the computer.

It should also be understood that manipulations within the computer are often referred to in terms such as displaying, deciding, storing, adding, comparing, moving, positioning, placing, and altering which are often associated with manual operations performed by a human operator. The operations described herein include machine operations performed in conjunction with various input provided by a human operator or user that interacts with the computer. In addition, it will be understood that the programs, processes, routines and methods described herein are not related or limited to any particular computer or apparatus, nor are they related or limited to any particular communication network architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

With the foregoing in mind, the drawing figures starting with FIG. 3 illustrate various functions, processes, or routines carried out by an embodiment of the present invention in which the disclosed virtual utility system 100 carries out the functions described in connection with the flow charts and database maintenance. The functions or processes in these figures are carried out in the disclosed embodiment of the present invention by software executing in computers associated with load-supplying entities 140, energy consumers 150, the VUM 110, and various energy markets 160. Depending upon the particular operation, the computers are connected for data communications via a network such as the Internet 101 or for communications via a communication network 101′ such as the public phone system (POTS). It will also be understood that the processes and methods presented here may be arranged differently, or steps taken in a different order. In other words, some processes and methods may be deleted, repeated, re-ordered, combined, or blended to form similar processes and methods.

FIG. 3 illustrates an embodiment of a hardware architecture 300 of a virtual utility manager constructed in accordance with the invention. The disclosed embodiment utilizes a tiered application architecture to distribute different application components over different servers. Please note that other embodiments of the present invention may combine certain application components onto the same server.

At the client tier 301, at which energy curtailment sellers and buyers interface with the VUM 110, consists of client legacy computers 301 running a web browser application that retrieves and displays the system's web pages. The client legacy computers 301 retrieve these web pages over a network tier, which is a telecommunication network such as the Internet 101. In addition, the legacy computers 301 run applications that receive email notifications and XML formatted files. As illustrated, the VUM 110 communicates with the legacy systems of energy consumers 302, legacy systems of load supply entities 304, legacy systems of trading exchanges 306, and legacy systems of ISOs 308.

Internet communications with the VUM 110 are effected by an Internet front end 310 including a router 311, a load balancer 313, and a firewall 315. The router 311 is operative in the known manner to send and receive data packets, typically in the form of TCP/IP packets commonly used for Internet communications. The load balancer 313 operates in known manner to balance the load from various communications amongst a plurality of computers or servers that are employed to construct the VUM 110. The data packets pass through a firewall 315, which ensures the overall security in a known manner before being passed to the web servers 330.

The web servers 330 include a plurality of redundant similarly configured computers, two of which are illustrated, that are operative to implement the front-end software. The web servers 330 are operative to direct on-line transactions, receive market pricing information, retrieve meter reading information, and display information to users operating a web browser. The web servers 330 are coupled to application servers 350.

The application servers 350 include a plurality of redundant similarly configured servers, three of which are illustrated, that are operative to implement the application software. The application servers 350 are operative to implement logic software utilized by the VUM 110. The software architecture is described in greater detail in reference to FIG. 4. The application servers 350 are coupled to the web servers 330, the notification servers 340, and the database servers 360.

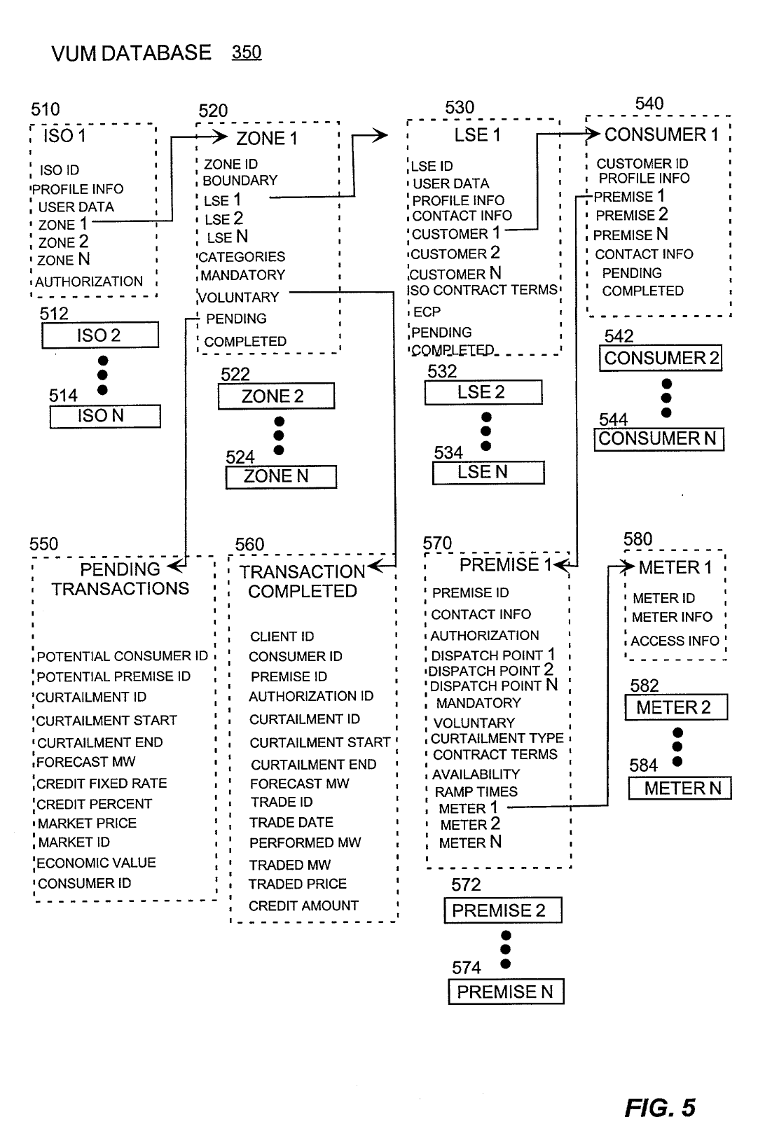

The database servers 360 include a plurality of redundant similarly configured servers, two of which are illustrated, that are operative to store and retrieve information from a database 350. The database servers are coupled to the application servers 330. Further details of the information stored in the database 350 is provided in connection with FIG. 5.

The notification servers 340 include a plurality of redundant similarly configured servers, two of which are illustrated, that are operative to provide non-Internet communications with the energy consumers 150 or load supply entities 140. The notification servers 340 are coupled to the application servers 350 and a bank of modems 320. The modem bank 320 provides the communication link between the notifications server 340 and the notification system 101′ such as the public telephone system for the transmission of automatically generated facsimiles, pages, or telephone communications.

Referring specifically now to FIG. 4, the principal software architecture 400 of the VUM 110 include a web interface 420, logic units 410, and backend systems that include a notification system 450, a market interface 460, and a meter interface 470.

The web interface 420 is operative to receive communications via the Internet 101 from load supply entities 140, energy consumers 150, ISOs 120. Web communications are in connection with provision of curtailment availability, the purchase or sale of curtailment reserves, curtailment monitoring, curtailment event notifications, and settlement information. In particular, the web interface 121 provides Internet-accessible interfaces for the notification module 422, for the dashboard 422, and for electronic file transfers.

The notification module 422 allows selection of the energy consumers 150 that are to notified about a curtailment opportunity. ISO can select the energy consumers 150 in a particular zone or the consumers that utilize curtailments types that are environmentally friendly such as load shedding on ozone non-attainment days. Load supply entities 140 that have load curtailment as part of their portfolio can select the energy consumers 150 which have dispatch points less than the current hourly market rate.

Upon selection, the notification module 422 reports the curtailment event details to the selected energy consumers 150. The energy consumers 150 can also access the notification module 422 to accept or decline the curtailment opportunity as per their contract obligations.

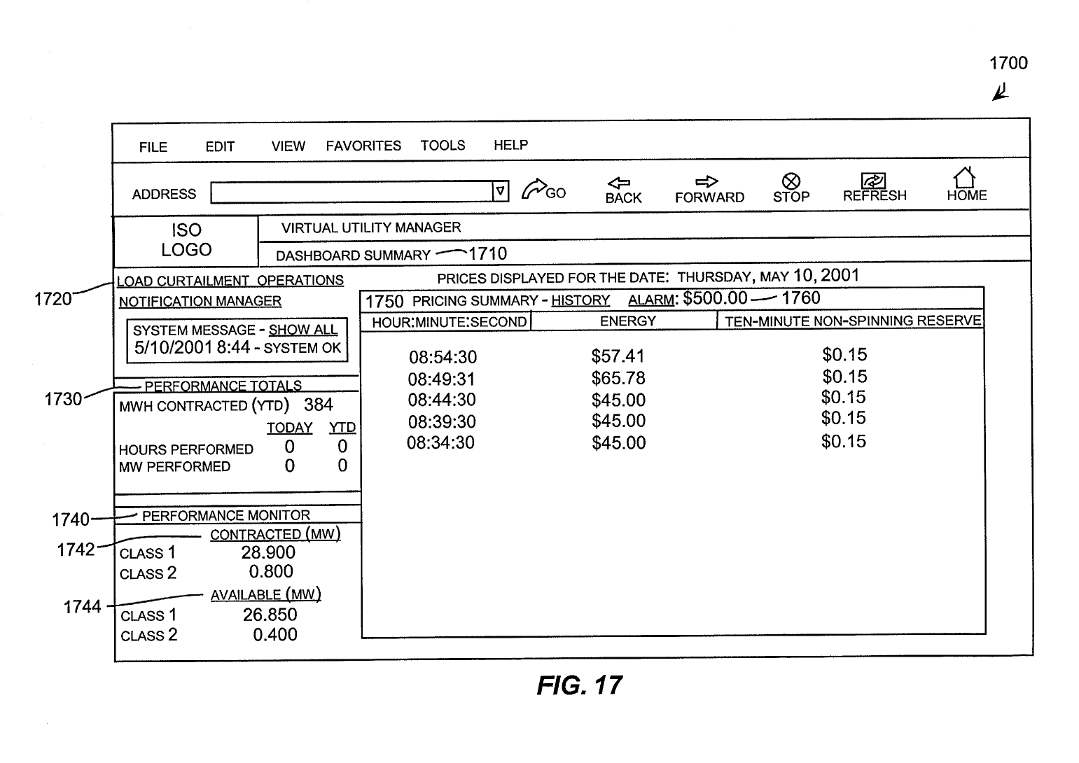

The dashboard 424 provides access via a web browser to trading histories, savings and credit information, system messages, and market prices. A screen shot of the graphical interface of one dashboard for an user is illustrated in reference to FIG. 17. The web interface 420 is also operative to receive electronic files in connection with account management, dispatch notification acceptance, and the creation of new customer accounts. These communications can take the form of multiple dialogues including Electronic Data Interchange (EDI), Extensible Markup Language (XML), and custom flat file formats.

The administrative logic unit 430 is operative to respond to communications, typically via web browser or electronic files, for the purpose of administrative functions. These functions include setting up employees as account users with the authority to authorize transactions, account management, editing of profiles, creation of new accounts, and addition of new energy consumers.

The curtailment logic unit 432 is operative to provide curtailment information to the holders of the contract rights to request curtailment energy. The curtailment logic unit 432 is operative to receive and store curtailment information including the revenue sharing terms. These terms can be provided on-line or by an agreed file format. In addition, the curtailment logic unit 432 provides the curtailment information for each consumer including the location, curtailment energy availability, curtailment type which includes on-site generation or load shedding, ramp rates, lead time, curtailment availability times, past curtailment performance, contract terms, and related information. The available curtailment is listed on the dashboard 424 as illustrated in a screen shot illustrated in reference to FIG. 17.

The aggregate logic unit is operative to aggregate individual curtailment contracts into curtailment amounts saleable on the trading exchanges 160 or to trading desks. In order to be saleable on the wholesale markets, the amount of energy available typically needs to be in the neighborhood of a 100 kilowatts. An enormous amount of curtailment energy is available in smaller energy savings. The aggregate logic unit groups the curtailment by categories. These categories include mandatory versus voluntary curtailments, the strike price at which a voluntary curtailment will be considered, availability times, lead times, load shedding versus on-site generation, and other factors. Once sufficient curtailment capacity is achieved through aggregation, the curtailment can be brought to market for liquidation.

The optimization logic unit 434 is operative to determine the value of the curtailment aggregation. Clearly, mandatory curtailment is more valuable than voluntary curtailment. Curtailment energy available any day of the week and time of day is more valuable than curtailment obligations with limited availability. Also, shorter required notification lead times are more valuable than longer lead times. However, future forecasts of energy availability is also important. These conditions include the predicted weather, the amount of generation expected to be down for maintenance, and the energy reserves in that region. These factors are determined and an estimated optimal price for the curtailment can be determined for the aggregated curtailment energy reserves.

The contract logic unit 438 is operative to provide on-line standard contracts for provision of curtailment energy. The curtailment information is received by the curtailment logic unit 432. Based upon the curtailment information, the contract logic unit 438 determines the proper contract forms. In addition, the contract 432 unit is operative to determine whether a fixed price is desired or a revenue sharing system is preferred. After determining the contract terms, the unit 438 ensures the signor is capable of executing the contract. The unit 438 then presents a contract for electronic signature.

The dispatch logic unit 440 is operative to receive curtailment notification requests and provide responses to the requests. Typically, the notification module 422 is utilized to generate a dispatch request. The requester selects the notification types. These types include the energy clearance price, mandatory curtailments, region of interest, and means of curtailment. In response to the selection, the notification unit presents the facilities, which meet the criteria and the amount of curtailment available. The requestor selects which consumers will receive the curtailment requests. The unit 440 retrieves the notification information and automatically generates a notification via the notification system 450. The consumers response 150 to the request is typically received via the notification module 422 and updates the responses to the requestors dashboard 424.

The performance logic unit 442 is responsive to an acceptance by the energy consumer 150 of a dispatch notification. The performance logic unit 442 is operative to monitor the curtailment of the energy consumer 150. The unit 442 monitors the associated meters 215 directly or retrieves the monitoring information from a meter information database 416 that stores meter readings typically on the consumers premises. The performance logic unit 442 is operative to update the dashboard 424 with the individual facilities' performances. The performance logic unit 442 is also operative to automatically send an alarm to the energy consumer 150 via the notification system 450 if the expected curtailment is not achieved.

The settlement unit 444 is operative to determine the final trade information. The unit 444 is operative to calculate from the trade information the credit owed to the energy consumer. The settlement unit updates the files for display via the web interface.

The market interface 460 provides communication links to the energy trading exchanges 160 or various trading desks. The market interface 460 receives signals from actively traded power exchanges, energy service provider trading desks, and independent system operators. The market interface is operative to post the curtailment energy and receive bids. If a bid is acceptable, the contract logic unit 432 is operative to provide a contract for electronic signature.

The meter interface system 470 is operative to receive meter information transmitted via the Internet or to access and retrieve the information from meter databases 416 in which the meter information resides.

A system database 350 forming a part of the system 110 stores information required for implementing the present invention.

According to an aspect of the invention, the computer programs described above collectively provide functions or components that form a virtual utility manager that provides aggregation and liquidation of curtailment resources. Greater details of these various functions and software components are described in subsequent FIGS.

FIG. 5 illustrates a data file structure of information stored in the VUM database 350. The information illustrated in FIG. 5 is organized logically in conventional data files in the known manner, associated with one or more procurers of curtailment reserves.

In the illustrated embodiment, the VUM 110 stores information associated with a plurality of different independent system operators 120, e.g. ISO 1 510, ISO 2 512, through ISO N 514. Each ISO 120 has various zones 130 under their management and associated with the ISO 120, e.g. ZONE 1 520, ZONE 2 522, through ZONE N 524. Load-supplying entities 140 are associated with energy consumers 150, e.g. CONSUMER 1 520, CONSUMER 2 522, through CONSUMER N 524. Likewise, energy consumers 150 may be associated with a plurality of premises, e.g. PREMISE 1 530, PREMISE 2 532, through PREMISE N 534. The energy consumer 150 or associated premise is associated with meters 215, e.g. METER 1 540, METER 2 542, through METER N 544, for monitoring of the performed load curtailment. Information stored in the database 350 can be retrieved for data manipulation and reporting.

In accordance with one disclosed embodiment, each independent system operator 120 has certain information associated with it. Illustrated is information stored in connection with a file for ISO 1 510. Such information includes the profile information that identifies the company such as by mailing address, billing information, and general contact points. The VUM 110 assigns each ISO 120 an identifier, ISO ID, to facilitate identification. Also associated with each ISO is the authorization information for authorizing a curtailment opportunity. Each ISO defines the user data that designates which employees that can authorize certain transactions. The authority level along with a user name and associated password or other security information are also stored as user data. An ISO 120 has grid management authority an area consisting of several zones 130. The zone data is associated with each zone 130, e.g. ZONE 1 520.

The VUM assigns each zone 130 a ZONE ID to facilitate identification of that zone 130. In addition, the zone boundary is associated with zone fields. The boundary information can be any geographical data that describes the boundary but is typically zip codes. The load-supplying entities 140 that have curtailment contracts for premises within a zone 132 are associated with the zone field 520. As illustrated, LSE 1 530, LSE 2 532, and LSE 3 534 are associated with ZONE 1 520. The zone information is utilized to assist an ISO 120 with grid management in that geographic area. Consequently, the curtailment energy available in zone 132 is associated with ZONE 1 520. The curtailment availability is separated into mandatory curtailment and voluntary curtailment with the associated energy-clearing price. In addition, the notification lead time, the curtailment availability times, the curtailment type such as on-site generation or load shedding, and similar information is associated with ZONE 1 520. Upon receiving a request to exercise curtailment contracts, a pending transaction file is opened 550. Upon the close of the curtailment event, a completed transaction file is generated and associated with the zone information.

In accordance with the disclosed embodiment, each load-supplying entity 140 has certain information associated with it. Illustrated is information stored in connection with LSE 1 530. Such information includes the company profile. Profile information identifies the company such as by mailing address, billing information, and general contact points. The VUM 110 assigns each LSE 140a, LSE identifier to facilitate identification. Also associated with each LSE 140 is the contact information for authorizing proceeding with an opportunity or declining a curtailment opportunity. Each LSE 140 designates the employees that can authorize certain transactions. The authority level along with a user name and associated password or other security information are stored as user data. Each load-supplying entity 140 will have a plurality of energy consumers 150 associated with it. Additionally, an energy-clearing price (ECP) is associated with each LSE 140. Optionally, the energy-clearing price can be associated with a consumer or a group of energy consumers 150 that are associated with a LSE 140. The energy-clearing price is the price at which load curtailment becomes economical. The information about the curtailment opportunity is stored in a pending transaction file 550.

The pending transaction action file 550 stores information about a curtailment event. Upon completion of a curtailment event, the VUM 110 updates a completed transaction file 560. When a curtailment event is requested, a pending transaction file 550 is created, and a curtailment identifier is assigned. The information contained in the file 550 includes the load-supplying entity identifiers and the potential consumers identifier. The curtailment start and end time are identified. A forecast energy curtailment is calculated based upon the stored information known about the premises. Based upon the forecast curtailment, an economic value to the energy consumer 150 can be calculated based upon the credit fixed rate or the credit percentage included in the contract terms. The market price and the associated market identifier are also associated with the pending transaction. When the LSE 140 proceeds with a curtailment opportunity, the energy consumers 150 designated for notification are associated with the pending transaction file 550.

Each load-supplying entity 140 has a plurality of energy consumers 110 associated with the LSE 140. Illustrated is information associated with a CONSUMER 1 file 540. Each consumer 150 is assigned by the VUM 110 a consumer identifier. Stored in connection with the consumer 150 is the consumer's profile information, notification information, and user data. Consumer's user data includes the user names, associated passwords, and authorization ability to accept or decline dispatch notifications. Each consumer 150 has one or more premises associated with the consumer 150. Premise specific information may be stored in associated premise fields 570. Additionally, each energy consumer 150 also has its relevant contract terms with its associated LSE 140 stored by the VUM 110.

The contract terms include the information on the price sharing with the LSE 140 and whether a curtailment is mandatory or voluntary. A consumer 150 has a fixed cost associated with any curtailment management strategy. For example, the energy consumer 150 knows the cost associated with running of an on-site generator or the economic loss associated with shutting down a production line. This cost is the dispatch point above which a load management deployment becomes economically advantageous. The contract terms specify how to share in the revenue generated by a curtailment above the dispatch point. The customer can be paid a fixed rate for load curtailment or split revenue with the LSE 430 based upon a credit percentage allocation.

When a trading desk 260 or an ISO 120 determines to notify a consumer about a curtailment opportunity, the designated consumers are associated with a pending transaction file 550. Upon the completion of a transaction, the associated completed transaction file 560 is updated.

The completed transaction file 560 associates the curtailment event with the corresponding LSE 140 and energy consumers 150. The curtailment identifier, the LSE identifiers, the consumer identifiers, and any corresponding premise identifiers are associated with the completed transaction file 560. The transaction file 560 will include the date, curtail start and end times, and the estimated energy curtailment. The file 560 also includes the actual trade data provided by the LSE 140 or other market participant. For example. The energy-clearing prices or the trade price can be provided by a regional Independent System Operator or an energy exchange 160. The trade data includes the trade identifier, the amount of energy traded, trade price, and actual credit amount received by the consumer.

Each load-supplying entity 140 is associated at least one associated premise. Illustrated is information stored in connection with a PREMISE 1 file 570. The premise information is stored in association with the corresponding consumer 150. The premise information includes the premise identifier assigned by the VUM 1100 and standard profile information. Each premise has at least one dispatch point and a corresponding operating expense as explained above. Additionally, each premise has at least one meter 115 associated with the premise to monitor the curtailment performed by the premise.

Each meter 115 has a meter identifier associated with the meter 115 to facilitate identification. Illustrated is information stored in connection with METER 1 580. If the meter 115 is capable of providing real time measurements via the Internet, the VUM 110 can readily store these meter readings. Otherwise, the access information for the meter 115 is stored. The access information includes the URL of the database with the meter readings and the access authorization information.

An electronic dashboard accessible by the operation of a web browser provides an easy mechanism to view or, in limited circumstances, edit most of the data stored by the VUM 110.

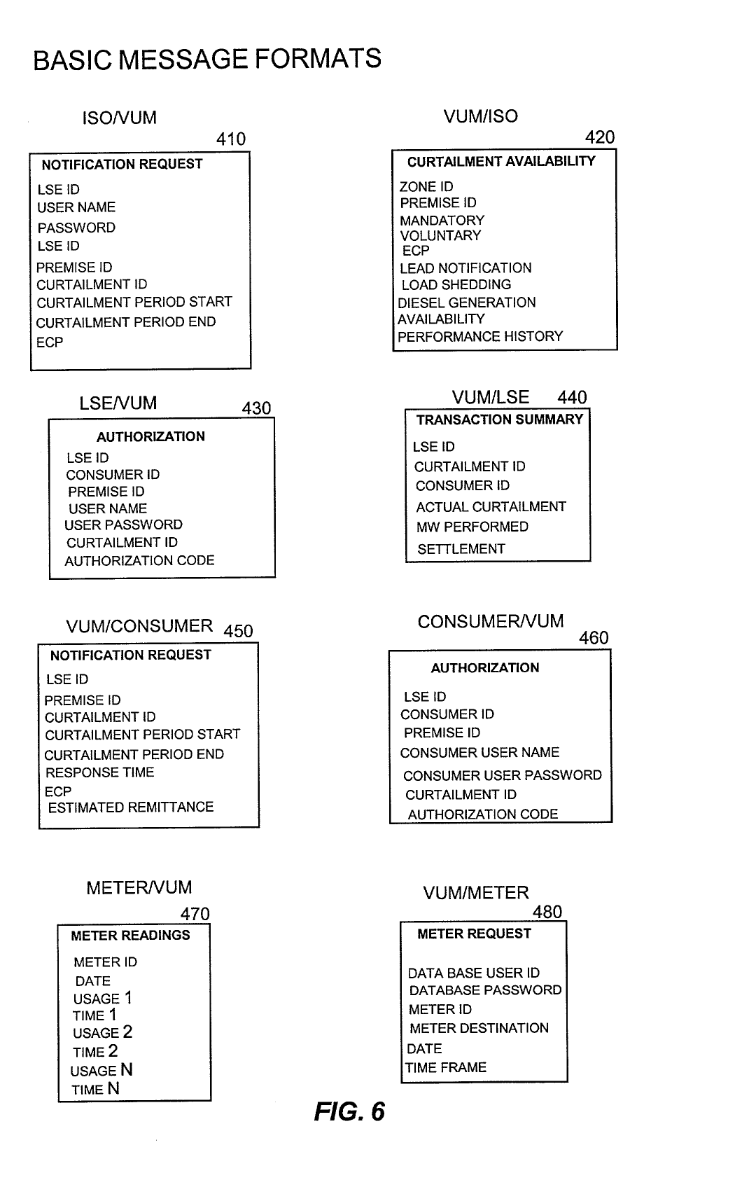

FIG. 6 illustrates the logical construction of some possible basic message formats that are passed between the various entities in the virtual utility system 100. Basic communications are exchanged between the VUM 110 and the independent system operators 120, meters 215, load-supplying entities 140, and energy consumers 150. These communications can take the form of multiple dialogues including Electronic Data Interchange (EDI), Extensible Markup Language (XML), and custom flat file formats. Additionally, some of these communications can be effected by way of a web browser interacting with the web interface residing on a web server. Alternately, statements, notifications, reports, and other communications can be accomplished by email and other electronic means.

In regard to communications between VUM 110 and the independent system operators 120, illustrated are two of the basic communications: a notification request 410 for enacting consumer curtailments and the provision of curtailment energy availability 420.

Notification requests 410 are generally initiated by on-line interaction of a browser application with the notification module 422. However, these communications can be accomplished by e-mail, file transfers, and other electronic data transfer means. The request includes the user name and password of a user with the authority to generate the request. The ISO 120 also identifies the premises and the associated LSEs 140 for which a curtailment is requested. The request 410 includes the energy-clearing price for providing the curtailment energy, as well as the curtailment start time and the estimated end time of the event.

Curtailment availability messages 420 are generally provided by on-line interaction of a browser application with the user's dashboard 424. However, these communications can be accomplished by e-mail, file transfers, and other electronic data transfer means. The curtailment availability is provided for each zone under the ISO control. The curtailment availability information 420 includes premise information and the associated energy-clearing price. Additionally, the availability message 420 includes whether the curtailment is mandatory or voluntary. Also provided is the curtailment performance history of the energy consumers. In addition, specific information is provided to help the overall grid management such as the notification lead time required, the availability times, and whether the curtailment is achieved through load shedding or on-site generation.

Upon the determination to proceed with a curtailment opportunity, a load-supplying entity 140 communicates with the VUM 110 to provide authorization 430. The authorization 430 can be effectuated by interfacing with the VUM 110 via a web browser or by a data file transfer. The authorization 430 includes the LSE identifier and the user name of the person authorizing the request and the associated password or other security measure. The authorization identifies the consumer by the consumer identifier and in some circumstances the premise by the premise identifier. The curtailment identifier provided by the VUM 110 identifies the particular curtailment opportunity. The curtailment period start and the curtailment period end are also included.

The VUM 110 concludes a curtailment event with the provision of the actual transaction data summary. This information can be effectuated by interfacing with the VUM 110 via a web browser or by the transmission of a transaction summary file. A transaction summary 440 includes the curtailment identifier and the associated LSE identifiers and consumer identifiers. The summary 440 includes details about the actual curtailment, the megawatts provided, and the settlement information based upon the contract information.

The VUM 110 provides the selected consumers with a curtailment notification request 450. The request provides the curtailment identifier, premise identifiers, and the associated LSE identifier. The request 450 states the curtailment start time, end time, as well as response-required time. The notification request 450 also provides the energy curtailment price associated with the curtailment opportunity.

The energy consumer 150 authorizes or declines the dispatch notification with an authorization message 460. This information can be effectuated by interfacing with the VUM 110 via a web browser or by the transmission of an authorization file. The authorization 460 includes the consumer identifier, the premise identifier, and the load supply entity. The consumer user providing the authorization supplies his user name and associated password for verification of the authority to bind the energy consumer 150. The authorization 460 includes the curtailment event identifier and an authorization code indicating an acceptance or a refusal of the dispatch.

Likewise, communications between the VUM 110 and a meter database 316 with the meter usage information include a meter request 480. The meter request 480 includes the user identifier and associated password or other security information to access the data. The meter request 480 specifies the meter identifier to identify the requested meter. The request also includes the destination to which the data should be transmitted. In addition, the request specifies the date and time frame desired.

The provided meter readings 470 from the meter database 316 includes the date of the reading, the time of the reading, and the actual energy consumption or energy produced by on-site generation.

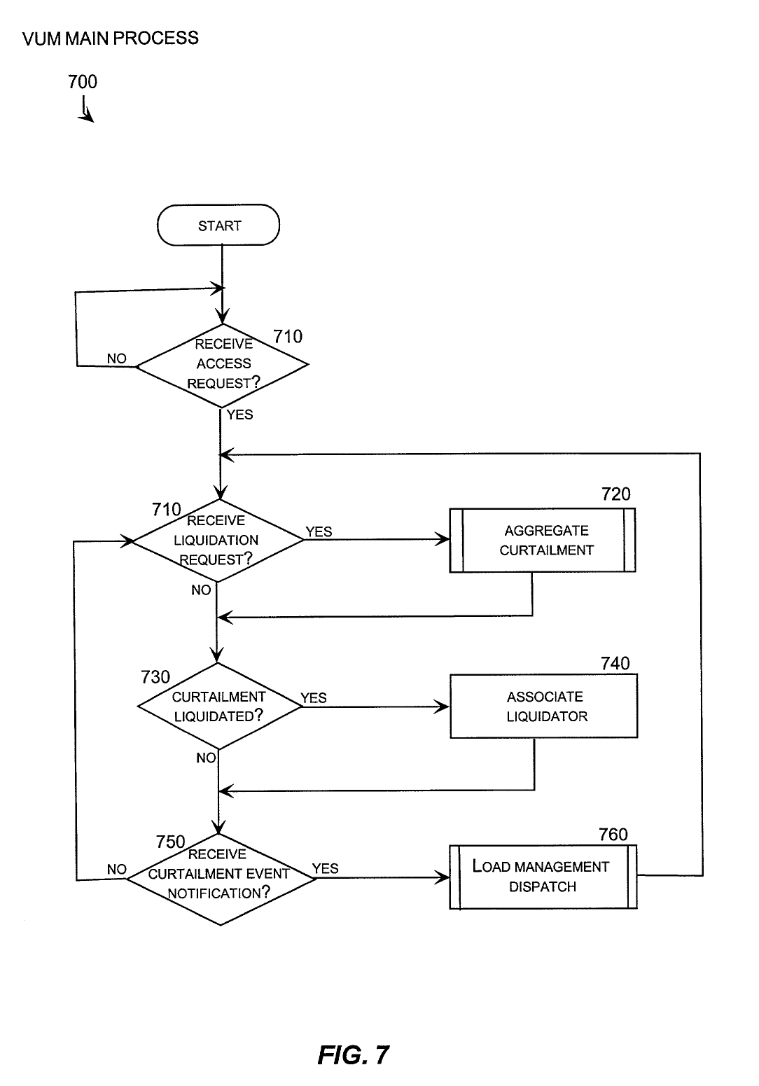

FIG. 7 discloses the main processes that are carried out with a virtual utility manager 110. The main process is initiated upon the receipt of a request to access a web page of the VUM 100. In step 705, the VUM determines if an access request has been received. If no access request is received, the NO branch of step 705 is followed to 705, in which the VUM awaits an access request. If an access request has been received, the YES branch of step 705 is followed to step 710.

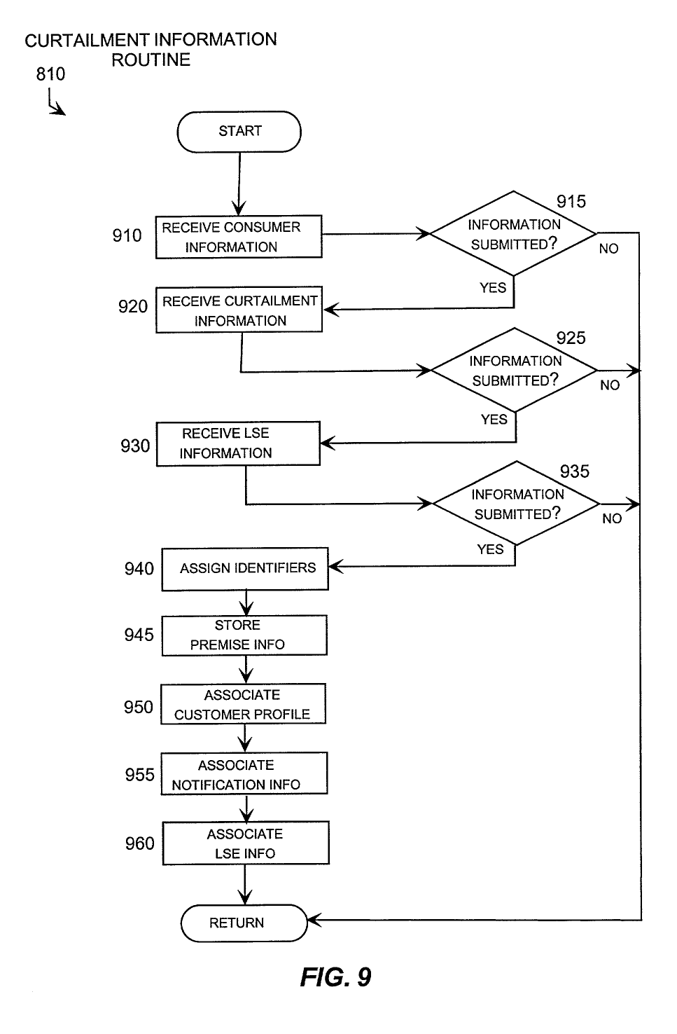

In step 710, the VUM 110 determines whether a liquidation request is being solicited. A liquidation request is generally solicited by a LSE 140 or an energy consumer 150 to achieve potential monetary return for their energy curtailment assets. If a liquidation request is received, the yes branch of step 710 is followed to routine 720, in which the curtailment energy availability is provided for sale to the energy markets. Routine 720 is described in greater detail in reference to FIG. 9. Routine 720 is followed by step 730. If a liquidation request is not received, the NO branch of step 710 is followed to step 730.

In step 730, the VUM 110 determines whether curtailment assets have been liquidated. If the curtailment energy has not been liquidated, the NO branch of step 730 is followed to step 750, in which the VUM determines if a curtailment event notification has been received. If the curtailment energy has been liquidated, the YES branch of step 730 is followed to step 740.

In step 740, the VUM associates the liquidated curtailment energy with the purchaser of the curtailment rights. The previously stored curtailment information and contract information is associated with the purchaser of the curtailment energy rights. The curtailment rights are determined by the agreed upon contract terms. One typical liquidator is an ISO 120 that desires to have the curtailment reserves available for grid management. Another liquidator is a large energy company desiring to manage their energy portfolios. The purchaser's profile information, assigned VUM identifier, user data, curtailment request authorization, contract information, and other information is associated with curtailment information provided by the curtailment energy seller. Step 740 is followed by step 750.

In step 750, the VUM determines if a curtailment event notification has been received. Generally, a curtailment event notification is initiated by interaction with the notification module described in greater detail in reference to FIG. 4. If a curtailment event notification has not been received, the NO branch of step 750 is followed and the process is returned to step 705, in which the VUM awaits an access request. If a curtailment event notification has been received, the YES branch of step 750 is followed to routine 760.

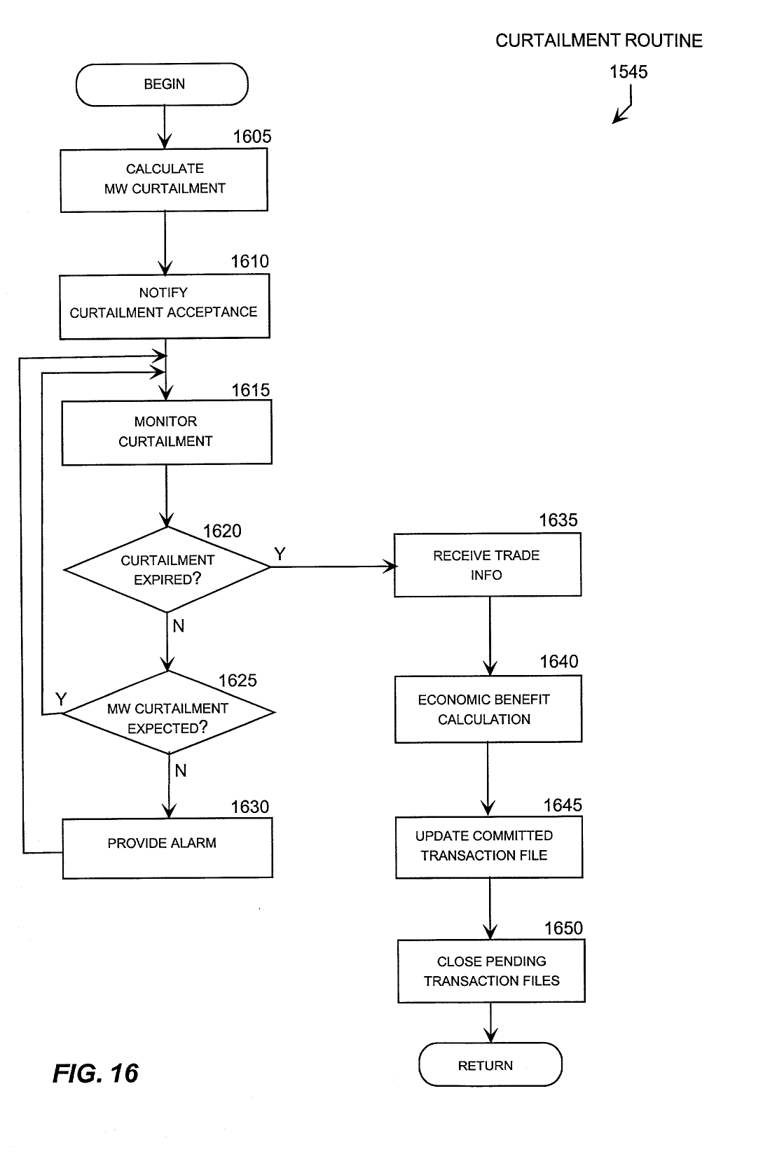

In routine 760, the VUM 110 performs load management dispatch, monitors any subsequent performance, and notifies the involved partied of associated curtailment settlement. Routine 760 is described in greater detail in reference to FIG. 16. Routine 760 is followed by step 710, in which VUM determines if any of the main processes are to be performed.

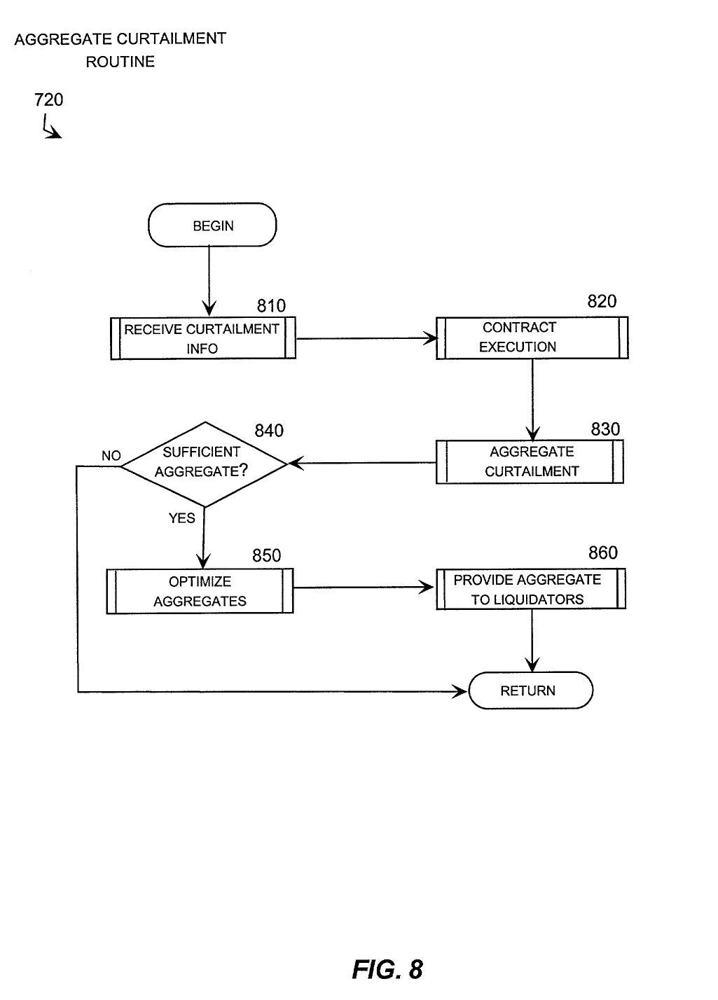

FIG. 8 illustrates an aggregate curtailment routine 720, which is carried out in response to a receipt of liquidation request. Routine 720 begins with routine 810, in which the VUM 110 receives the curtailment information. The curtailment information is provided by interaction with the web interface 420 associated with the VUM 110 by a web browser application operated by a legacy computer system. Routine 810 is described in further detail in reference to FIG. 9. Routine 810 is followed by routine 820.

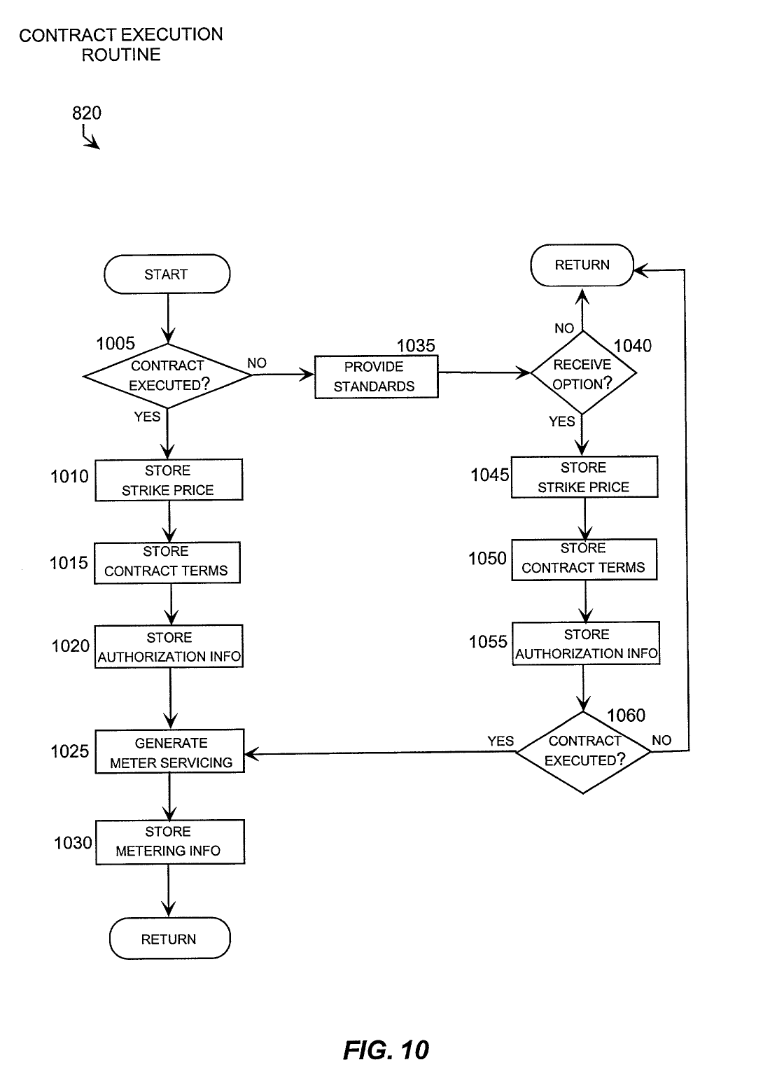

In routine 820, the VUM 110 receives the contract information, if any. A load-supplying entity 140 may have curtailment contract terms negotiated with their associated energy consumers 150. The contract information is provided to the VUM 100 to enable the VUM 100 to provide settlement information for any curtailment event. This contract information is provided by interaction with the web interface 420 associated with the VUM 110 by a web browser application operated by a legacy computer system. Routine 820 is described in further detail in reference to FIG. 10. Routine 820 is followed by routine 830.

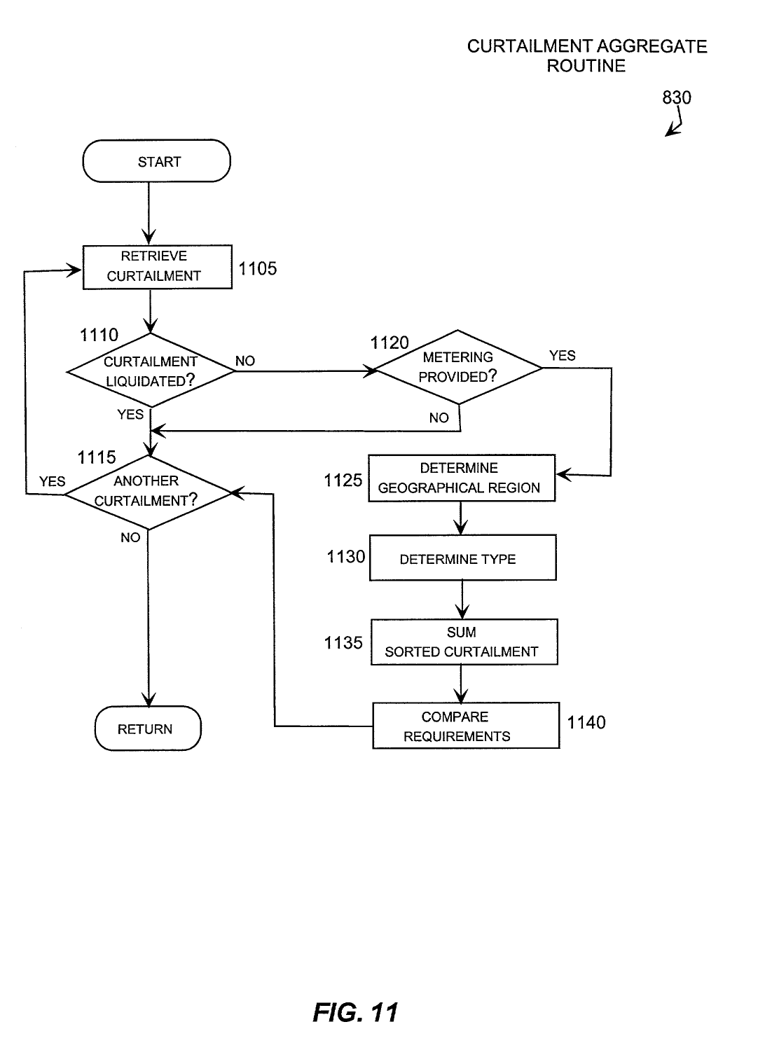

In routine 830, the VUM aggregates the available curtailment into categories and quantities capable of being readily sold on the wholesale markets. Routine 830 is described in greater detail in reference to FIG. 11. Routine 830 is followed by step 840.

In step 840, the VUM determine if sufficient curtailment energy is available to provide to wholesale liquidators. If the aggregate is insufficient, the NO branch of step 840 is followed and the routine is returned to perform step 730 of FIG. 7. If the aggregate is sufficient, the YES branch of step 840 is followed to perform routine 850.

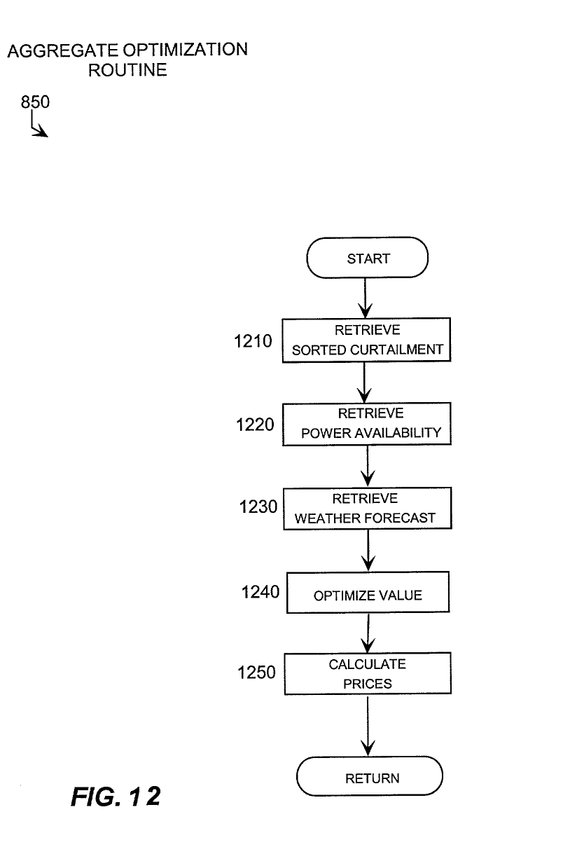

In routine 850, the VUM performs an optimization of the available curtailment to determine market value. Routine 850 is described in greater detail in reference to FIG. 12. Routine 850 is followed by routine 860.

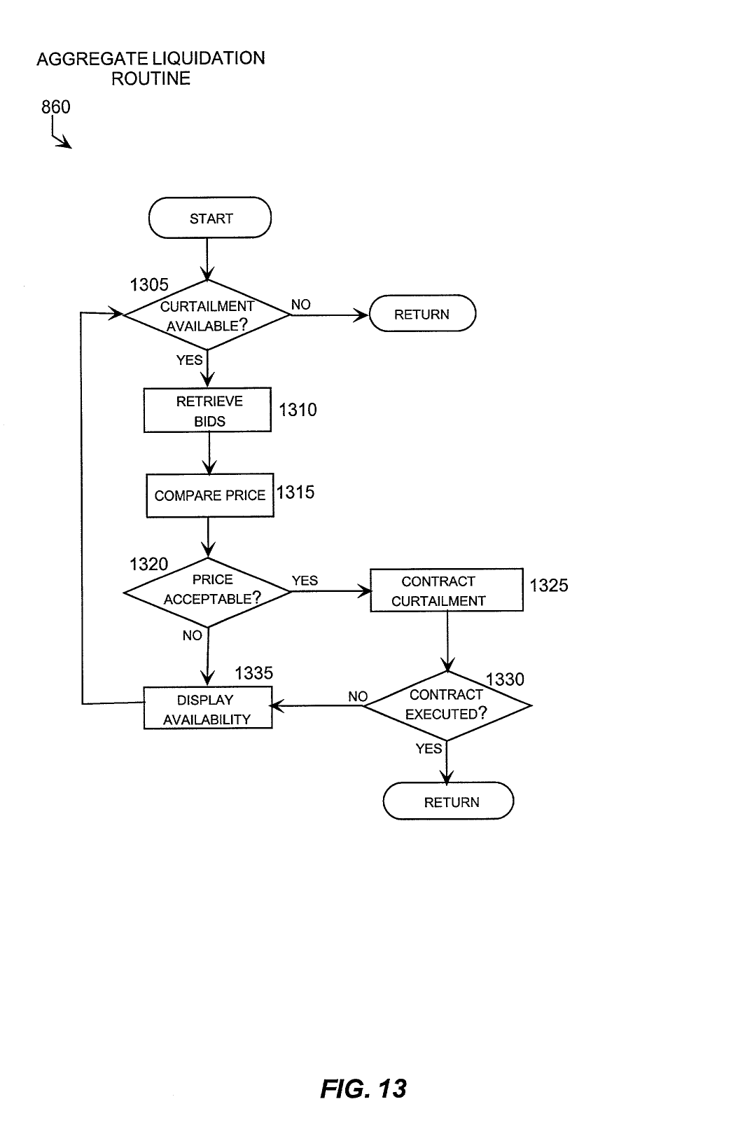

In routine 860, the VUM provides the aggregate to the wholesale markets. Routine 860 is described in greater detail in reference to FIG. 13. After routine 860, the process is returned to perform step 730 shown in FIG. 7.

FIG. 9 illustrates a curtailment information routine 810, which is carried out in response to a request to provide curtailment information. Routine 810 begins with step 910, in which the VUM 110 receives consumer information. The consumer information is provided by interaction with the web interface 420 associated with the VUM 110 by a web browser application operated by a legacy computer system. The consumer information is entered by requesting entity by known web browser techniques. The requesting entity is usually a LSE 140 that has a load curtailment agreement in force with an energy consumer 150. However, an energy consumer 150 desiring to profit from its curtailment assets 210 may provide this information directly. This consumer information requested includes the consumer profile information and user data.

Step 910 is followed by step 915, in which the VUM 110 determines whether the consumer information has been submitted. If the requestor has declined to submit the consumer information, the NO branch of step 915 is followed and the routine is returned to perform routine 820 of FIG. 8. If the requestor has submitted the consumer information, the YES branch of step 915 is followed to step 920.

In step 920, the VUM 110 receives curtailment information. The curtailment information is provided by interaction with the web interface 420 associated with the VUM 110 by a web browser application operated by a legacy computer system. The consumer information is entered by a requesting entity by known web browser techniques. The curtailment information requested includes the consumer premises information, the available curtailment at each premise, the type of curtailment such as load shedding or on-site generation, the lead time required, the time and day of week for the availability of the curtailment, and curtailment authorization information.

Step 920 is followed by step 925, in which the VUM 110 determines whether the curtailment information has been submitted. If the requestor has declined to submit the curtailment information, the NO branch of step 925 is followed and the routine is returned to perform routine 820 of FIG. 8. If the requestor has submitted the curtailment information, the YES branch of step 925 is followed to step 930.

In step 930, the VUM 110 receives load-supplying entity information. The LSE information is provided by interaction with the web interface 420 associated with the VUM 110 by a web browser application operated by a legacy computer system. The LSE information is entered by a requesting entity by known web browser techniques. The LSE information requested includes contact information and contract terms for supplying energy. The contract information includes the agreed terms for supplying electricity. The contract may include terms for mandatory or voluntary curtailment and the associated the strike price at which the consumer has agreed to consider curtailment activities.

Step 930 is followed by step 935, in which the VUM 110 determines whether the LSE information has been submitted. If the requestor has declined to submit the LSE information, the NO branch of step 935 is followed and the routine is returned to perform routine 820 of FIG. 8. If the requestor has submitted the LSE information, the YES branch of step 935 is followed to step 940.

In step 940, the VUM assigns identifiers. The VUM checks the provided information against previously stored information to determine if any identifier has been previously assigned. If not previously assigned, the VUM assigns identifiers for each consumer, LSE, and premise.

Step 940 is followed by step 945, in which the VUM 110 stores the premise information including the associated curtailment information for each premise. Step 945 is followed by step 950, in which the VUM associates the customer profile information with the curtailment information. Step 950 is followed by step 955, in which the VUM 955 associates the notification information with the curtailment information. Step 955 is followed by step 960, in which the VUM associates the LSE with the curtailment information. The information stored in the VUM database 350 is described in greater detail in reference to FIG. 5. After step 960, the routine is returned to perform routine 820 of FIG. 8.

FIG. 10 illustrates a contract execution routine 810, which is carried out in response to a request to liquidate available curtailment energy. Routine 820 begins with step 1005, in which the VUM 110 determines whether a contract to provide curtailment energy is already executed. This information is provided by interaction with the web interface 420 associated with the VUM 110 by a web browser application operated by a legacy computer system.

A load-supplying entity 140 may have a previously executed contract to provide curtailment energy upon request. A LSE 140 can contract with an ISO 120 or with a trading desk 260 to provide curtailment energy. In which case, the LSE negotiates curtailment contracts with their energy consumers 150 to supply the curtailment energy information to the VUM 110. If a previous contract to supply curtailment energy has not been executed, the NO branch of step 1005 is followed to step 1035, in which standard contracts are presented for execution. If a previous contract to supply curtailment energy has been executed, the YES branch of step 1005 is followed to step 1010, in which the contract terms are provided.

In step 1010, the contract strike price above which curtailment requests will be considered are provided and stored. Step 1010 is followed by step 1015, in which the contract terms are provided and stored. The contract terms include the revenue splitting, whether the curtailment is mandatory or voluntary, and other relevant information. Step 1015 is followed by step 1020, in which the authorization information is stored. The authorization information is the contact and security information to authorize acceptance of a curtailment event. Step 1020 is followed by step 1025.

In step 1025, the VUM, automatically generates a meter servicing request. Upon receipt of the meter servicing request, personnel associated with the VUM 110 ensure that proper metering is available for monitoring curtailment performance. If no current metering is adequate, the energy consumer 150 can lease or purchase the meters 115. In addition, meter may be provided by their LSE 140 or any other mechanism to ensure proper monitoring of curtailment performance.

In step 1030, the metering information is provided and stored. Typically, this information is provided by the personnel that installs the meters 115. After step 1030, the routine is returned to perform routine 830 of FIG. 8.

In step 1035, the VUM 110 presents standard contracts for execution. The contracts are to provide curtailment energy to an ISO or a trading desk upon request. The VUM 110 has standardized contracts for mandatory or voluntary curtailment performance. The contracts have options for revenue splitting or a set prices per kilowatt-hour performed. The requestor can choose the contract desired. Information concerning the contracting party is automatically inserted into the contracts presented from the stored curtailment information.

Step 1035 is followed by step 1040, in which the VUM determines if the requestor has chosen a contract option. If no option is acceptable, the NO branch of step 1040 is followed and the routine is returned to perform step 830 of FIG. 8. If a contract option is selected, the YES branch of step 1040 is followed to step 1045.

In step 1045, the VUM associates the strike price contained in the contract at which the requestor will be notified of a curtailment opportunity. Step 1045 is followed by step 1050, in which the VUM associates the contract terms with the requestor. Step 1050 is followed by step 1055, in which the authorization information is stored. The authorization information is the contact and security information to authorize acceptance of a curtailment event. Step 1055 is followed by step 1060.

In step 1060, the VUM 110 determines if the contract is executed by the requestor. The contract can be electronically signed per applicable statutes. If the requester refuses to sign the contract, the NO branch of step 1060 is followed and the routine is returned to perform step 830 of FIG. 8. If the requestor signs the contract, the YES branch of step 1060 is followed to step 1025, as described above.

FIG. 11 illustrates a curtailment aggregate routine 830, which is carried out in response to the receipt curtailment contract information. Routine 830 begins with step 1105, in which the VUM 110 retrieves curtailment availability data.

Step 1105 is followed by step 1110, in which the VUM 110 determines if the curtailment availability currently being processes has been liquidated. If the curtailment energy has been liquidated, the YES branch of step 1110 is followed to step 1115, in which the VUM determines if another curtailment energy record needs to be aggregated. If no more curtailment energy is available for aggregation, the NO branch of step 1115 is followed and the routine is returned to perform step 840 of FIG. 8. If more curtailment energy records are available for aggregation, the YES branch of step 1115 is followed to step 1105.

If the curtailment energy has not been liquidated, the NO branch of step 1110 is followed to step 1120, in which the VUM determines if metering is available to monitor curtailment performance. If metering is not available, the NO branch of step 1120 is followed to step 1115, in which the VUM 110 determines other curtailment reserves are available for processing. If metering is available, the YES branch of step 1120 is followed to step 1125.

In step 1125, the VUM determines the geographical region of the curtailment energy reserves. Curtailment energy is grouped and liquidated by region. Step 1125 is followed by step 1130, in which the VUM determines the curtailment type. Voluntary curtailment over certain standard energy-clearing prices are grouped together. Likewise, mandatory curtailment is grouped separately from the voluntary curtailments. In addition, curtailment energy can be grouped by on-site generation versus load shedding. Certain areas may have restrictions on operating diesel generators during ozone non-attainment periods especially during the summer months. The curtailment energy is sorted by the previously determined classifications.

Step 1130 is followed by step 1135, in which the VUM 110 sums the total available curtailment energy in each classification. Step 1140 is followed by step 1145, in which the VUM compares the totals to predetermined criteria. Differing categories and regions may have slightly different quantities to be able to be sold to the wholesale markets. If the quantity is sufficient, the curtailment energy will be presented for liquidation. Step 1140 is followed step 1115, in which the VUM 110 determines if other curtailment energy reserves are available for aggregation.

FIG. 12 illustrates an aggregate optimization routine 850, which is carried out in response to aggregation of the curtailment energy reserves. Routine 850 begins with step 1210, in which the VUM 110 retrieves curtailment data sorted by classification and region.

Step 1210 is followed by step 1220, in which the VUM 110 retrieves the power availability forecast for the region. Power available forecasts are entered into the system by personnel. If these projections are available in electronic formats, the projection may be electronically retrieved or updated. Power forecast are routinely generated by experts in the field. The forecasts are based upon the expected availability of power production plants. Power plants are routinely non-operational due to scheduled outages and unexpected circumstances.

Step 1220 is followed by step 1230, in which the predicted weather forecast is entered into the system. Weather experts routinely predict the weather for the upcoming months. Energy usage is highly dependent on the temperature. Extreme cold or extreme heat for prolong periods drastically effect the demand for energy. The average predicted temperatures for the period of interest is entered into the system by personnel associated with the VUM. If these projections are available in electronic formats, the projection may be electronically retrieved or updated. Step 1230 is followed by step 1240.

In step 1240, the VUM runs an optimization routine on the aggregate curtailment to estimate the worth. In regions of expected power shortages, curtailment energy may be more valuable than other parts of the country. Various factors effecting energy prices are weighted and used to estimate a value. These factors include expected power availability, expected demand, the forecasted weather, the current energy prices, and other factors known the industry. If a forecast is unavailable, the weight is assigned a value indicating an average forecast.

Step 1240 is followed by step 1250, in which the VUM 110 calculates the estimated value of curtailment energy resources based upon the preceding optimization values. After step 1250, the routine is returned to perform routine 860 of FIG. 8.

FIG. 13 illustrates an aggregate liquidation routine 860, which is carried out in response to estimation of curtailment value. Routine 860 begins with step 1305, in which the VUM 110 determines curtailment availability for liquidation on the wholesale markets.

If the VUM 110 determines that no curtailment energy is available for liquidation on the wholesale markets, the NO branch of step 1305 is followed and the routine is returned to perform step 730 of FIG. 7. If the curtailment energy is available for liquidation, the YES branch of step 1305 is followed to step 1310. In step 1310, the VUM determines the price offered wholesale marketers. Offers can be received by interaction with the VUM web interface by known browser techniques or by known file transfer techniques specifying price, region, and prearranged classifications. Step 1310 is followed by step 1315.

In step 1315, the VUM compares each bid. Step 1315 is followed by step 1320, in which the VUM 110 determines if the estimated value and any bid is within acceptable margins of the estimated value of the energy curtailment to the purchaser.

If a bid is not acceptable, the NO branch of step 1320 is followed to step 1335, in which the VUM 110 display the availability of the energy curtailment on its web site. Step 1335 is followed by step 1305, in which the VUM determines if curtailment energy is available for liquidation.

After determining the highest acceptable bid, the YES branch of step 1320 is followed to step 1325. In step 1325, a prearranged contract is offered. The amount is automatically determined from offered bid. Step 1325 is followed by step 1330.

In step 1330, the VUM 110 determines if the contract is electronically signed and executed. The performance of electronic signatures are well known in the art. If the contract is not executed, the NO branch of step 1330 is followed to step 1335, in which the VUM 110 display the curtailment availability for bids. If the contract is executed, the YES branch of step 1330 is followed and the routine is returned to perform step 730 of FIG. 7.

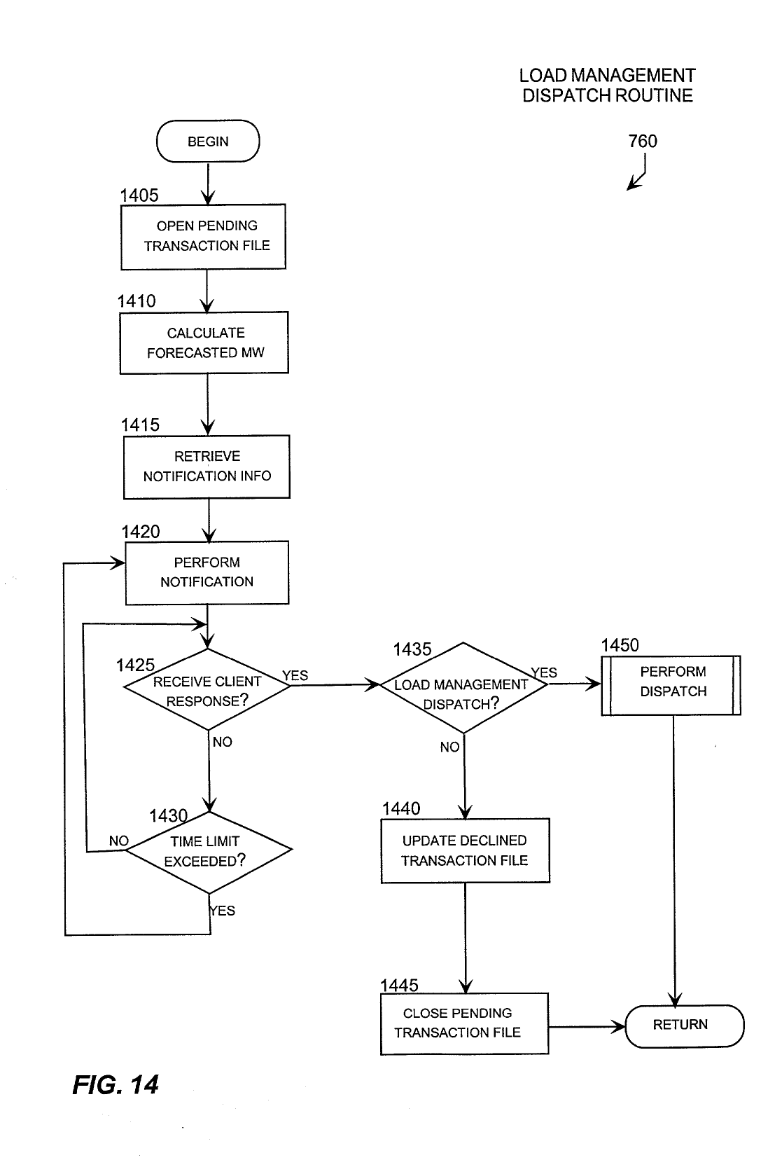

FIG. 14 illustrates a load management dispatch routine 760, which is carried out in response to curtailment notification request.

Beginning at step 1405, the VUM 110 opens a pending transaction file to store information about the curtailment opportunity. Step 1405 is followed by step 1410, in which the VUM 110 calculates the proposed energy curtailment. As part of a load management strategy, energy consumers have determined the economic dispatch point for their on-site generation or their load shedding assets. The consumers also have provided their corresponding expected generation or load shedding energy curtailment for each dispatch point. From this information, the VUM 10 can calculate the proposed energy reduction. The VUM 110 also has stored the contract terms the energy consumer has with its associated load-supplying entity 140. From the contract terms and the proposed energy reduction, the VUM 110 can calculate estimates of the amount of financial gain to be achieved by a curtailment event.

Step 1410 is followed by step 1415, in which the VUM 110 retrieves the notification information. Step 1415 is followed by step 1420, in which the VUM 110 automatically performs the notification of a curtailment opportunity. The notification can be accomplished by an e-mail delivered by the Internet. Other notification means include an automatically generated telephone call, a facsimile, a wireless communication delivered via a wireless transmitter to a pager, mobile phone, or other wireless device, a wireless message delivery by wireless application protocol (WAP) to a hand held computing device, or other suitable methods for delivering the message.

Step 1420 is followed by step 1425, in which the VUM 110 determines whether a response to the curtailment opportunity notification has been received. If the VUM 110 has not received a response, the NO branch of step 1425 is followed to step 1430, in which the VUM 110 has determined if the time limit for the receipt of a response has been exceeded. If the VUM 110 has received a response, the YES branch of step 1425 is followed to step 1435, in which the VUM 110 acts in accordance with the response.

In step 1430, the VUM 110 determines whether the time limit for the receipt of a response has been exceeded. If the time limit has not been exceeded, the NO branch of step 1430 is followed to step 1425, in which the VUM 110 awaits a response. If the time limit has been exceeded, the YES branch of 1430 is followed to step 1420, in which the VUM 110 provides another notification of the curtailment opportunity.

In step 1435, VUM 110 determines whether the LSE 140 has decided to act on the curtailment opportunity. If the load-supplying entity 140 has declined to proceed with a load management dispatch, the NO branch of step 1435 is followed to step 1440, in which the VUM 110 updates a declined transaction file.

In step 1440, the VUM 110 updates the declined transaction file. The declined transactions are logged to provide statistical and other information about declined curtailment opportunities. Step 1440 is followed by step 1445, in which the LMD closes the pending transaction file. After the performance of step 1445, the routine is returned to perform step 710 of FIG. 7.

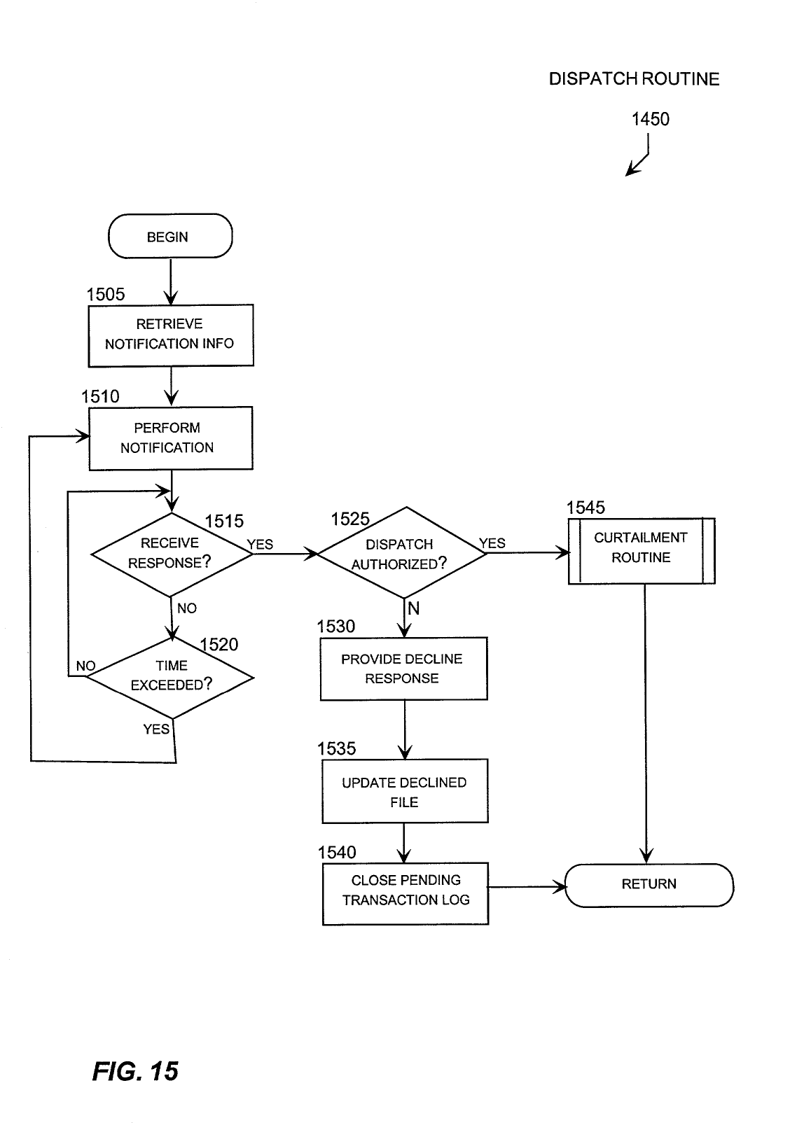

If the load-supplying entity has decided to proceed with the load management dispatch, the YES branch of step 1435 is followed to routine 1450, in which the VUM 110 performs the dispatch notification to the associated energy consumers 150. Routine 1450 is described in greater detail in reference to FIG. 15. After the performance of routine 1450, the routine is returned to perform step 710 of FIG. 7.

FIG. 15 illustrates an energy consumer dispatch notification routine 1450, which is carried out in response to a load-supplying entity decision to proceed with a curtailment opportunity.

The routine begins with step 1505, in which the VUM 110 retrieves the notification information for a dispatch opportunity. Step 1505 is followed by step 1510, in which the automated notification of the energy consumer 150 is performed. The notification can be accomplished by an e-mail delivered by the Internet. Other notification means include an automated telephone call, a facsimile, a wireless communication delivered via a wireless transmitter to a pager, mobile phone, or other wireless device, a wireless message delivery by wireless application protocol (WAP) to a hand held computing device, or other suitable methods for delivering message to the energy consumer 150.

Step 1510 is followed by step 1515, in which the VUM 110 determines if the energy consumer 150 has responded to the dispatch notification. If a response has not been received, the NO branch of step 1515 is followed to step 1520, in which the VUM 110 determines whether the time limit for the receipt of a response has been exceeded. If the time limit has not been exceeded, the NO branch of step 1520 is followed to step 1515, in which the VUM 100 awaits a response. If the time limit has been exceeded, the YES branch of 1520 is followed to step 1510, in which the VUM 110 provides another notification of the dispatch opportunity. If a response has been received, the YES branch of step 1515 is followed to step 1525, in which the VUM 110 determines if the dispatch is authorized.

In step 1525, the VUM 110 determines whether a dispatch is authorized. If the dispatch is authorized, step 1525 is followed by step 1545, in which the VUM 110 performs the curtailment routine. Routine 1545 is described in greater detail in reference to FIG. 16. If the dispatch is not authorized, step 1525 is followed by step 1530, in which the VUM 110 provides the LSE 140 with notification of the energy consumer rejection of the dispatch opportunity. The dispatch rejection can be provided by e-mail or any other notification means sufficient to notify the energy service provider of the energy consumer's decision.

Step 1530 is followed by step 1535, in which the VUM 110 updates the declined transaction log. The declined transaction log enables the VUM to easily retrieve information from declined transaction files about curtailment opportunities bypassed by the energy consumer. Step 1535 is followed by step 1540, in which the VUM 110 closes the pending transaction file. After step 1540, the routine is returned to perform step 710 of FIG. 7.

FIG. 16 illustrates a curtailment routine 1545 performed by the VUM 110. The curtailment routine is initiated in response to authorizing an energy curtailment dispatch.

At step 1605, the VUM 110 calculates the expected energy curtailment. As part of the energy consumer's load management strategy, the reduction of load from the grid is established for each load shedding asset or on-site generation capability. The reductions from all of the accepted energy consumers are totaled by the VUM 110.

Step 1605 is followed by step 1610, in which the load-supplying entity 140 is notified of the energy consumer 150 acceptance of the dispatch notification. Additionally, the VUM 110 provides the LSE 140 with the expected energy curtailment. This information can be delivered by email, displayed by the notification tool, or delivered by electronic file transfers.

Step 1610 is followed by step 1615, in which the VUM 110 monitors the curtailment. If the premise performing the load curtailment has an IP meter, the VUM 110 can monitor the actual load reduction or on-site generation in real time via the Internet. Step 1615 is followed by step 1620, in which the VUM 110 determines if the curtailment period has expired. If the curtailment period has expired, the YES branch of step 1620 is followed to step 1635, in which the VUM 110 receives the actual trade information. If the curtailment period has not expired, the NO branch of step 1620 is followed to step 925, in which the VUM 110 determines if the actual energy curtailment matches the expected energy reduction.

At step 1625, the VUM 110 determines whether the energy actual energy curtailment matches the expected energy curtailment. If the actual curtailment matches the expected curtailment, the YES branch of step 1625 is followed to step 1615, in which the VUM 110 continues to monitor the curtailment. If a discrepancy exists between the actual and expected curtailment, the NO branch of step 1625 is followed to step 1630, in which the VUM 110 provides an alarm to the energy consumer. The alarm is an automated notification performed in a similar manner as the notification of the dispatch opportunity. Step 1630 is followed by step 1615, in which the VUM 110 continues to monitor the curtailment.

At step 1635, the VUM 110 receives the actual trade information from the energy service provider or other energy market participant. The energy market participant supplies the VUM 110 with the actual energy sold and the sell price. Step 1635 follows by step 1640, in which the VUM 110 calculates the actual economic benefit for the energy consumer based upon the contract terms.

Step 1640 is followed by step 1645, in which the VUM 110 updates a committed transaction file with the actual trade information and curtailment information. The energy consumer 150 is able to view this information by accessing the dashboard via the Internet by the operation of a web browser. Step 1645 is followed by step 1650, in which the VUM 110 closes the pending transaction file and the curtailment event is complete. After step 1650 is performed, the routine is returned to perform step 710 of FIG. 7.

Turning to FIG. 17, the screen shot illustrates an Internet web page 1700 displayed by the VUM 110 in response to a login from an independent system operator. The dashboard 1700 displays information general curtailment information. The dashboard summary display 1710 informs the user that the screen is the dashboard summary.

A notification manager selection object 1720 provides a link to the notification manager. Screen shots of web pages displayed by the VUM 110 in response to the activation of the notification manager selection object 1720 are illustrated in reference to FIG. 18-20. The notification manager provides automated notification of curtailment events.

A performance total region 1730 provides the year to date contracted megawatt hours. The region 1730 also lists the hours and megawatt performed today as well as year to date totals.

The performance monitor region 1740 provides the contracted megawatts listing 1742 by class. In addition, the region 1740 lists the available megawatts 1744 for the particular day and time.

The dashboard includes an energy display region 1150 that displays energy prices. The energy pricing defaults to the current date. The display lists the time in five-minute intervals, the associated energy price, and the ten-minute non-spinning reserve price. A history option is available to view energy prices for past dates and times. An alarm selection object 1760 enables the user to select the alarm price at which the display prices will be presented in red.

FIG. 18 illustrates an exemplary notification manager page 1800. The notification manager page 1800 is displayed in response to a activation of the notification manger selection object 1710 as described in reference to FIG. 17. The notification manager display 1810 informs the user that the page is the notification manager.

The page 1800 allows selection of the notification type 1820. A notification type drop down box 1822 lists for selection the notification types. As illustrated, the current selection is class 1 curtailment or mandatory curtailment. Facilities operating under mandatory curtailment contracts cannot refuse to effectuate the curtailment upon request.

The program manager 1830 enable easy selection of the curtailment program. The program allows the selection by drop down box 1832 of the zone or region for the desired notification type. As illustrated, the program is class 1 curtailments in the Boston region.

The facilities region 1840 lists the premises that for the program selected. The facility description and the curtailment energy available is provided. The user can select by standard double clicking the facilities for the curtailment notification. A total available megawatts display 1850 is also provided.

The curtailment event information box 1860 enables the user to enter the event specifics. The curtailment date, start time, end time, and any custom message is entered by the user in the appropriate text box. Activation of the submit button 1865 causes the VUM 110 to provided the curtailment event information to the selected participants.

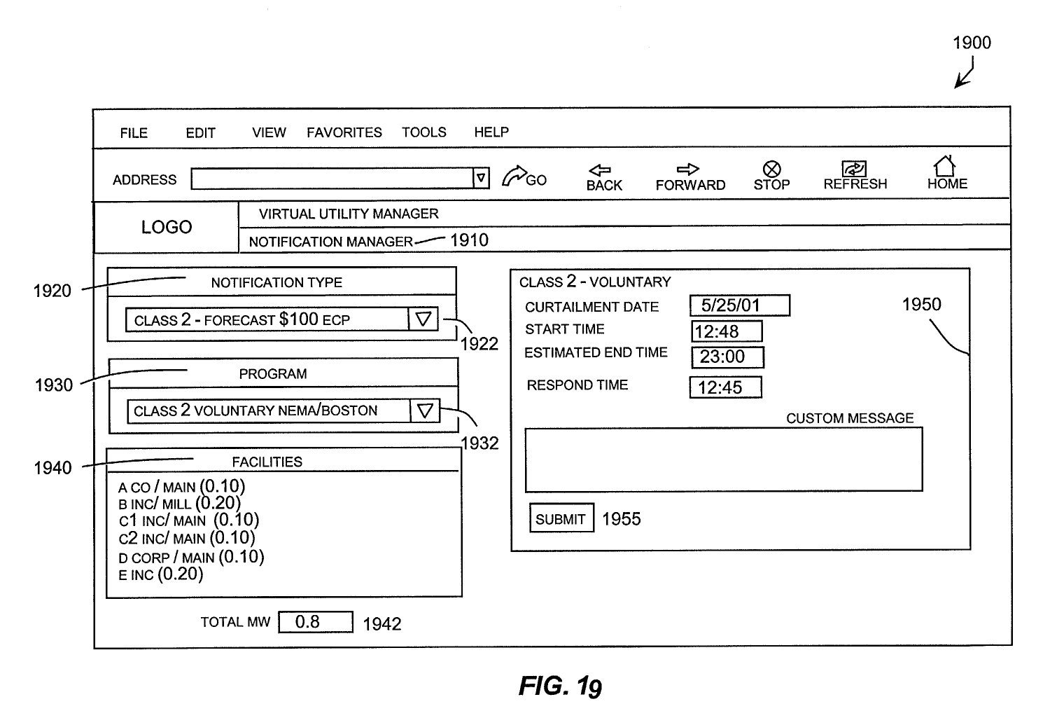

FIG. 19 illustrates an exemplary notification manager page 1900 for a voluntary curtailment notification. The notification manager page 1900 is displayed in response to a activation of the notification manger selection object 1710 as described in reference to FIG. 17. The notification manager display 1910 informs the user that the page is the notification manager.

The page 1900 allows selection of the notification type 1920. A notification type drop down box 1922 lists for selection the notification types. As illustrated, the current selection is class 2 curtailment or voluntary curtailment. Facilities operating under voluntary curtailment contracts elect to participate on an event by event basis. As illustrated, the energy-clearing price forecast is $100. The energy-clearing price is the price at which the associated facilities will consider curtailment events.

The program manager 1930 enable easy selection of the curtailment program. The program allows the selection by drop down box 1932 of the zone or region for the desired notification type. As illustrated, the program is class 2 curtailments in the Boston region.

The facilities region 1940 lists the premises that for the program selected. The facility description and the curtailment energy available is provided. The user can select by standard double clicking the facilities for the curtailment notification. A total available megawatts display 1950 is also provided.

The curtailment event information box 1950 enables the user to enter the event specifics. The curtailment date, start time, end time, response required time, and any custom message is entered by the user in the appropriate text box. Activation of the submit button 1965 causes the VUM 110 to provided the curtailment event information to the selected participants.

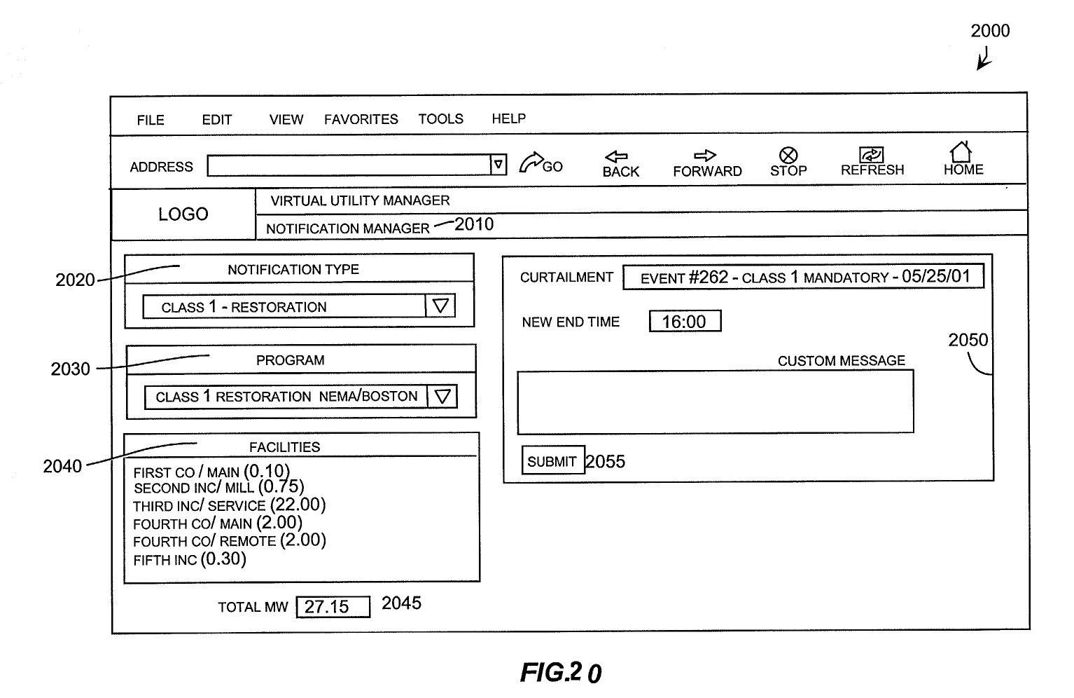

FIG. 20 illustrates an exemplary notification manager page 2000 for a curtailment notification restoration. The notification manager page 2000 is displayed in response to a activation of the notification manger selection object 1710 as described in reference to FIG. 17. The notification manager display 2010 informs the user that the page is the notification manager.

The page 2000 allows selection of the notification type 2020. A notification type drop down box 2022 lists for selection the notification types. As illustrated, the current selection is class 1 restoration.

The program manager 2030 enable easy selection of the curtailment program. The program allows the selection by drop down box 2032 of the zone or region for the desired notification type. As illustrated, the program is class 1 restoration in the Boston region.

The facilities region 2040 lists the premises that for the program selected. The facility description and the curtailment energy available is provided.

The curtailment event information box 2050 enables the user to enter the event specifics. The curtailment event identification and the new end time is entered by the user in the appropriate text box. Activation of the submit button 2055 causes the VUM 110 to provided the curtailment event restoration information to the selected participants.

In view of the foregoing, it will be appreciated that the invention provides a system for aggregation and liquidation of curtailment energy assets. It should be understood that the foregoing relates only to the exemplary embodiments of the present invention, and that numerous changes may be made therein without departing from the spirit and scope of the invention as defined by the following claims. Accordingly, it is the claims set forth below, and not merely the foregoing illustration, which are intended to define the exclusive rights of the invention.

The invention claimed is:

1. A method for energy load curtailment, comprising the steps of:
receiving curtailment energy commitment data via a communication network;
aggregating the curtailment energy commitment data;
providing aggregated curtailment commitment data to energy market purchasers for purchase of the energy curtailment rights;

2. The method of claim 1, wherein the step of aggregating the curtailment energy data comprises aggregating said curtailment energy data by geographic area and by at least one other category.

3. The method of claim 1, further comprising the step of receiving executed curtailment contract data via the communication network.

4. The method of claim 3, wherein the step of receiving executed curtailment contract data comprises the step of:
receiving curtailment contract data:
executing electronically a curtailment energy contract.

5. The method of claim 1, further comprising the step of performing optimization calculation to determine approximate value of curtailment energy rights.

6. The method of claim 1, further comprising the step of performing receiving meter data for monitoring of curtailment events.

7. The method of claim 1, further comprising the step of associating the aggregated curtailment commitment data with curtailment energy rights purchaser data.

8. The method of claim 1, further comprising the steps of:
receiving curtailment request message via the communication network;
transmitting a curtailment request notification to at least one energy consumer;
receiving meter performance data;
providing monitoring data via the communication network to at least one curtailment event participants.

9. The method of claim 8, further comprising the steps of:
calculating monetary remuneration for performance of a curtailment event;
providing remuneration data to at least one curtailment event participants.

10. A method for energy load curtailment, comprising the steps of:
receiving curtailment energy commitment data via a communication network;
receiving executed curtailment contract data via the communication network;
aggregating the curtailment energy commitment data;
performing optimization calculation to determine approximate value of curtailment energy rights;
receiving meter data for monitoring of curtailment events;
providing aggregated curtailment commitment data to energy market purchasers for purchase of the energy curtailment rights;
associating the aggregated curtailment commitment data with curtailment energy rights purchaser data;
receiving curtailment request message via the communication network;
transmitting a curtailment request notification to at least one energy consumer;
receiving meter performance data; and
providing monitoring data via the communication network to curtailment event participants.

11. The method of claim 1, wherein the step of aggregating the curtailment energy data comprises aggregating said curtailment energy data by geographic area and by at least one other category.

12. A method for energy load curtailment, comprising the steps of:
receiving curtailment energy commitments;
aggregating the curtailment energy commitments;
providing aggregated curtailment commitments to energy market purchasers;

13. The method of claim 12, wherein the step of aggregating the curtailment energy commitments comprises aggregating said curtailment energy commitments by geographic area and by at least one other category.

14. The method of claim 12, further comprising the step of receiving executed curtailment contract information.

15. The method of claim 12, wherein the step of receiving executed curtailment contract information comprises the steps of:
receiving curtailment contract information; and
executing electronically a curtailment energy contract.

16. The method of claim 12, further comprising the step of performing optimization calculation to determine approximate value of curtailment energy rights.

17. The method of claim 12, further comprising the step of monitoring a curtailment event.

18. The method of claim 12, further comprising the step of associating the aggregated curtailment commitments with curtailment energy rights purchaser.

19. The method of claim 12, further comprising the steps of:
receiving curtailment request;
transmitting a curtailment request notification;

20. The method of claim 19 further comprising the steps of:
receiving meter performance data;
providing monitoring information to a curtailment event participant.

21. The method of claim 12, further comprising the steps of:
calculating monetary remuneration for performance of a curtailment event;
providing remuneration information to at least one curtailment event participants.

22. A method for energy load curtailment, comprising the steps of:
receiving curtailment energy commitments;
receiving executed curtailment contract information;
aggregating the curtailment energy commitments; and
providing aggregated curtailment commitments for purchase of the energy curtailment rights.

23. The method of claim 22, further comprising the steps of:
receiving curtailment request;
transmitting a curtailment request notification;
receiving meter performance; and
providing monitoring information.

24. The method of claim 12, wherein the step of aggregating the curtailment energy commitments comprises aggregating said curtailment energy commitments by geographic area and by at least one other category.

25. A system for energy load curtailment, comprising:
a computer system operative to receive curtailment energy commitment data via a communication network;
the computer system operative to aggregate the curtailment energy commitment data;
a database couple to the computer system operative to store the curtailment energy commitment data; and
a communication mechanism coupled to the computer system operative to provide aggregated curtailment commitment data to energy market purchasers for purchase of the energy curtailment rights.

26. The system of claim 25, wherein the computer system includes logic operative to aggregate said curtailment energy data by geographic area and by at least one other category.

27. The system of claim 25, wherein the computer system includes logic operative to execute a curtailment contract.

28. The system of claim 25, wherein the computer system includes logic operative to perform optimization calculations to determine approximate value of curtailment energy rights.

29. The system of claim 25, wherein the communication mechanism is operative to receive meter data for monitoring of curtailment events.

30. The system of claim 25, wherein the database associates the aggregated curtailment commitment data with curtailment energy rights purchaser data.

31. The system of claim 25, wherein the computer system include logic operative to perform the steps of:
receiving curtailment request message;
transmitting a curtailment request notification;
receiving meter performance data;
providing monitoring data.

32. The system of claim 25, wherein the computer system includes logic operative to perform the steps of:
calculating monetary remuneration for performance of a curtailment event;
providing remuneration data to at least one curtailment event participants.
